(19) United States
(12) Patent Application Publication
(10) Pub. No.: US 2026/0260862 A1
(43) Pub. Date: Sep. 3, 2026

(54) METHOD FOR RECONSTRUCTING A MASS SPECTRUM

(71) Applicants: SYNCHROTRON SOLEIL, Saint-Aubin (FR); INSTITUT NATIONAL DE RECHERCHE POUR L'AGRICULTURE, L'ALIMENTATION ET L'ENVIRONNEMENT, PARIS (FR)

(72) Inventors: Félix SERVANT, ORSAY (FR); Laurent NAHON, PARIS (FR); Alexandre GIULIANI, PARIS (FR)

(21) Appl. No.: 19/489,946

(22) PCT Filed: Jun. 4, 2024
(86) PCT No.: PCT/EP2024/065342

§ 371 Date: Dec. 4, 2025

(30) Foreign Application Priority Data
Jun. 5, 2023 (FR) 2305634

(51) Int. Cl. H01J 49/00

(52) U.S. Cl. CPC H01J 49/0036

(57) ABSTRACT

The invention relates to a method for reconstructing a mass spectrum, the method comprising the following steps: —acquiring (1010) a plurality of mass spectra measured on an ionised sample; —determining (1020) a plurality of series of abundance values for the ionised sample; —arranging (1030) series of abundance values in pairs comprising a first series and a second series; —for each pair, calculating (1040) a match score between the first series and the second series in order to provide a match score map between all the pairs of the series; —determining (1060), according to a mass-to-charge ratio, at least one precursor ion and fragment ions that are associated with each precursor ion by applying a clustering method to the score map; —reconstructing (1070) a mass spectrum for each precursor ion and for each of the associated fragment ions using the match score map.

### TECHNICAL FIELD OF THE INVENTION

The present invention relates in general to a method for reconstructing a mass spectrum.

It relates in particular to a method for reconstructing an individual mass spectrum of at least one precursor ion based on the use of a series of mass spectra.

It also relates to a device implementing such a method.

### PRIOR ART

Mass spectrometry (MS) is an analysis technique used to detect ions originating from a sample and to analyze these ions as a function of their (m/z) ratio, where m represents the mass of an ion and z represents its electric charge. Mass spectrometry is used in many applications to analyze, identify and characterize the chemical structure of ionized molecules.

A mass spectrometer generally comprises an ionization source for forming ions from a sample to be analyzed, an analyzer that separates ions according to their m/z ratio, and a detector. A mass spectrum is obtained by recording the abundance of ions as a function of their mass-to-charge (m/z) ratio. However, simple mass spectrometry makes it possible only to measure the m/z ratio, and does not make it possible to differentiate ions having identical m/z ratios, in particular because of the resolution limit of the spectrometer used. In addition, measuring the m/z ratio does not provide any information about the composition or structure of ions.

It is known practice to use tandem mass spectroscopy to study ions of interest in a sample more precisely. Such a technique makes it possible to provide an individual mass spectrum for a given precursor ion after activation. For this purpose, tandem mass spectrometry comprises, after the molecules of the sample have been ionized, a step of selecting an ion of interest using a mass filter. This selected ion is then subjected to an activation step, which consists in increasing its internal energy, which may lead to it being fragmented. The produced ions resulting from the fragmentation of the selected ion (also called precursor ion or parent ion) are then analyzed in one or more other mass spectrometry steps carried out on the fragment ions thus generated, wherein the mass analysis steps are able to be separated spatially or temporally depending on the instrument used.

For example, tandem mass spectrometry may be implemented by isolating an ion of interest in an ion trap by providing it with an amount of internal energy, through collision with a gas, that is sufficient for it to fragment. Detecting the products of this fragmentation may provide information about the nature and/or structure of the precursor ion. Tandem mass spectrometry forms the basis for mass spectrometry applications in structural analysis, and in particular the sequencing of proteins and other biopolymers (such as sugars or nucleic acids).

Tandem mass spectrometry does work, but requires more sophisticated instruments that generally comprise two mass analyzers coupled in series, thereby adding complexity to spectrometers and also increasing costs and maintenance thereof.

Tandem mass spectrometry is also limited by instrumental constraints, in particular selection finesse, which, in some cases, is not sufficient to separate two ions of interest having very similar mass (very similar m/z ratio). In this case, two ions that are different but have similar m/z ratios will be selected and activated simultaneously. The tandem mass spectrum that is obtained will therefore be the sum of the tandem mass spectra of the two simultaneously selected ions, thereby complicating interpretation of the measurements.

Tandem mass spectrometry may also be slower in terms of analysis speed compared to other methods, due to the sequential acquisition of data. Indeed, the ions of interest are selected and fragmented one after another.

Furthermore, in tandem mass spectrometry, a criterion for choosing the ions to be analyzed in a sample is required. In this case, it is often necessary to have a list of ions of interest that it is desired to fragment, this being tantamount to having a priori knowledge of the sample. In one variant, it is also possible to choose to fragment all ions the intensity of which exceeds a certain fixed threshold, again according to the sample. Prior knowledge of the sample is therefore required.

Data-independent mass spectrometry (data independent acquisition, DIA) is an advanced technique used notably in proteomics (see document US2017/0032948). However, it requires systematic fragmentation of all ions present in a series of m/z ratio windows covering a range of m/z ratios.

The invention aims to rectify at least one of the abovementioned drawbacks.

### PRESENTATION OF THE INVENTION

In order to rectify the abovementioned drawback of the prior art, the present invention proposes a method for reconstructing a mass spectrum, said method comprising the following steps:
acquiring a plurality of mass spectra measured on an ionized sample comprising at least one precursor ion and fragment ions,
determining a plurality of series of abundance values of the ionized sample based on the plurality of mass spectra, each series of abundance values of the ionized sample being determined based on the plurality of mass spectra, each series of abundance values comprising N abundance values, where N is an integer greater than or equal to two;
arranging the plurality of series of abundance values into pairs of series of abundance values, each pair of series of abundance values comprising a first series of abundance values and a second series of abundance values,
for each pair of series of abundance values, calculating a correspondence score between the first series of abundance values and the second series of abundance values, so as to obtain correspondence scores for all pairs of series of abundance values, the correspondence scores providing a correspondence score map between all pairs of series of abundance values,
determining, based on a mass-to-charge ratio, at least one precursor ion and fragment ions associated with each determined precursor ion, by applying a clustering method to the calculated correspondence score map,
reconstructing an individual mass spectrum of each determined precursor ion and of each of the associated fragment ions based on the correspondence score map.

Thus, by virtue of the invention, in particular of the various steps of the method according to the invention, it is possible to find out the mass spectrum of an individual ion present in a mixture (that is to say a sample that may contain multiple ions and fragments) without necessarily using a tandem mass spectroscopy device. Therefore, the present invention is able to carry out tandem mass spectrometry analyses based on a series of simple mass spectra that have been acquired by a mass spectroscopy device that is not provided with a second mass filter (here an ion trap), but in which either the desorption/ionization step causes species fragmentation, or by implementing an in-source activation step by collision-induced dissociation (or in-source collision-induced dissociation, in-source CID) in order to activate all ionized species. As a result, the method is therefore easier to implement and less expensive compared to a method requiring working using tandem mass spectrometers.

Moreover, although this method works based on a series of mass spectra, the calculation step and the use of a clustering algorithm makes it possible to precisely group together at least one precursor ion and the fragments associated with this precursor ion. Such a method therefore works on mass spectra acquired with devices the selection width of which is sometimes too large to isolate an ion precisely. The invention may also be used to identify the presence of isobaric species in a tandem mass spectrometry experiment. As a result, the method according to the invention also makes it possible to work on all types of acquired mass spectra. In other words, the method makes it possible to overcome the technical limitations of mass spectrum devices, which may be related to measurement resolution or to constraints related to the ionization sources used.

Other advantageous and non-limiting features of the method according to the invention, taken individually or in any technically feasible combinations.

In one embodiment, the step of determining a series of abundance values comprises determining a series of ranges of mass-to-charge ratio values for the plurality of measured mass spectra of size N×M, with M an integer greater than 1, and for each mass spectrum of the plurality of mass spectra, a step of integrating abundance values belonging to one and the same range of mass-to-charge ratio values of the considered mass spectrum, in order to provide, for each range of mass-to-charge ratio values of the considered spectrum, an integrated abundance value associated with a determined mass-to-charge ratio in each range of mass-to-charge ratio values, the abundance values integrated over the series of ranges of mass-to-charge ratio values forming a series of abundance values of the ionized sample.

In one embodiment, the correspondence score is based on at least one of the following elements:
mutual information between the first series of abundance values and the second series of abundance values, said mutual information being based on an entropy of the first series of abundance values and on an entropy of the second series of abundance values; and/or
a correlation between the first series of abundance values and the second series of abundance values.

In one embodiment, for the mutual information, the entropy of the first series of abundance values is an entropy normalized by a first invariance parameter dependent on a first median value determined over this first series of abundance values, and the entropy of the second series of abundance values is an entropy normalized by a second invariance parameter dependent on a second median value determined over this second series of abundance values.

In one embodiment, with the correspondence score being based on mutual information, the method comprises a step of estimating the entropy of the first series of abundance values and a step of estimating the entropy of the second series of abundance values using a k-nearest neighbors algorithm.

In one particular and advantageous example, the k-nearest neighbors algorithm is applied to a single neighbor.

In one embodiment, when at least two correspondence scores based on two different elements are calculated in the calculation step, multiple score maps are provided following the calculation step, said method furthermore comprising, for each score map, a step of filtering said score map as a function of a contrast of the considered score map.

In one embodiment, the method furthermore comprises a step of processing the score map before applying the clustering method, said processing step using at least one of the following algorithms:
a standardization algorithm,
an algorithm for processing diagonal elements of the score map,
application of a square function.

In one embodiment, the score map is a two-dimensional matrix, the clustering method determining the at least one precursor ion and its associated fragment ions based on correspondence scores located outside a diagonal of the score map.

In one embodiment, the clustering method uses at least one unsupervised learning algorithm.

In one embodiment, the clustering method is based on at least one of the following algorithms:
a hierarchical agglomerative clustering algorithm,
a k-nearest neighbors algorithm,
a k-means algorithm,
a distributed stochastic neighbor embedding algorithm.

In one embodiment, the method furthermore comprises, after the reconstruction step, a step of analyzing the individual mass spectrum of the determined precursor ion and the associated fragment ions in order to characterize the chemical composition of the determined precursor ion and the chemical composition of the fragment ions associated with the considered precursor ion.

In one embodiment, the method comprises a step of processing the acquired mass spectra, comprising at least one of the following calculations:
filtering the given mass spectrum by way of a Gaussian or normal kernel,
normalizing the given mass spectrum,
smoothing the given mass spectrum,
baseline correction.

In one embodiment, the method comprises a step of processing the series of abundance values, comprising at least one of the following calculations:
filtering the given series of abundance values by way of a Kalman filter;
filtering the given series of abundance values by way of a Fourier filter;
filtering the given series of abundance values by way of a moving average.

In one embodiment, the method comprises a compressed acquisition step in order to reduce the number of acquisitions.

In one embodiment, the plurality of mass spectra comprises at least 1000 mass spectra, preferably between 2000 and 8000 mass spectra.

In one exemplary embodiment, an external variation based on chromatographic separation, ion mobility separation and/or discriminant transmission of ion optics is applied during the acquisition step so as to modify or modulate the abundance of ions, and the number of mass spectra of the plurality of mass spectra is less than or equal to 10, for example equal to 5 mass spectra.

Of course, the various features, variants and embodiments of the invention may be combined with one another in various combinations provided that they are not incompatible or mutually exclusive.

### DETAILED DESCRIPTION OF THE INVENTION

The following description, given with reference to the appended drawings, which are provided as non-limiting examples, will clarify the subject matter of the invention and how it may be realized.

In the appended drawings:

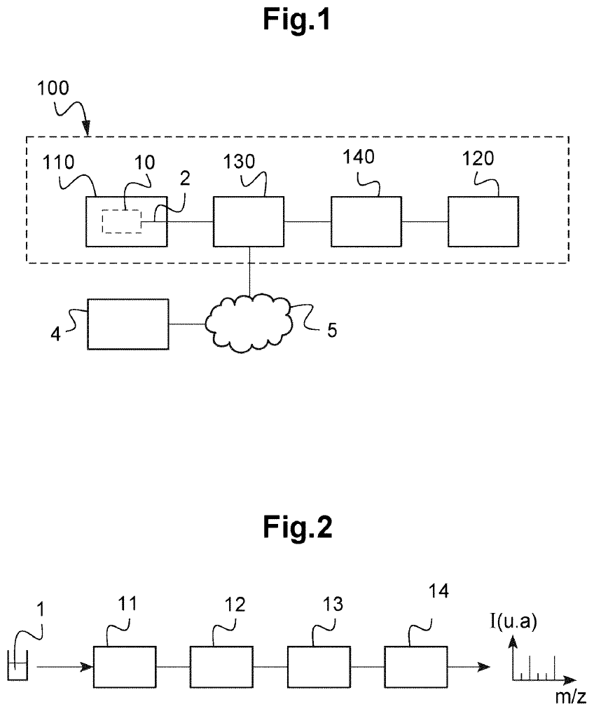

FIG. 1 is a schematic depiction of a device for reconstructing an individual mass spectrum of at least one precursor ion according to the present disclosure;

FIG. 2 is a schematic depiction of a mass spectroscopy device used in the device according to the present disclosure;

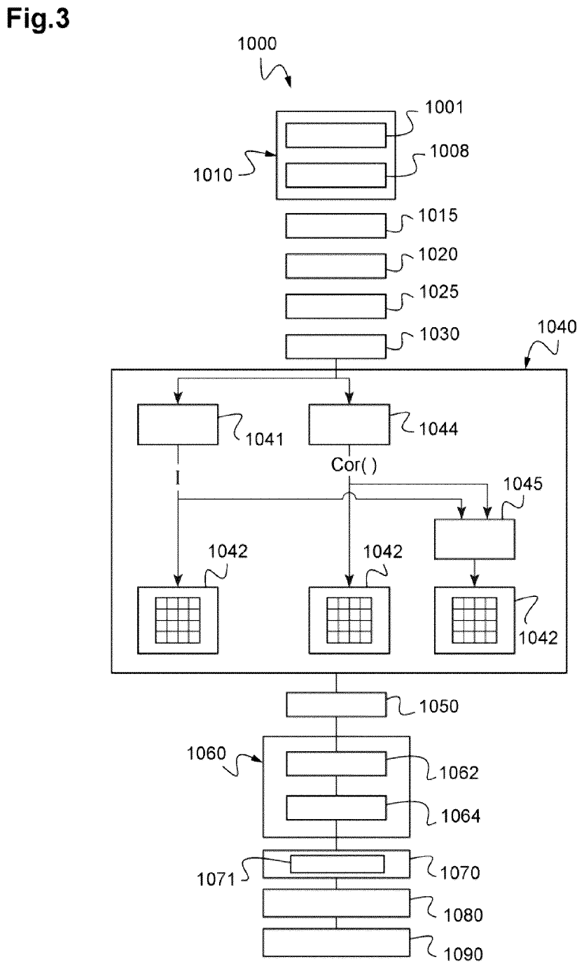

FIG. 3 is a schematic depiction of one example of a method according to the present disclosure;

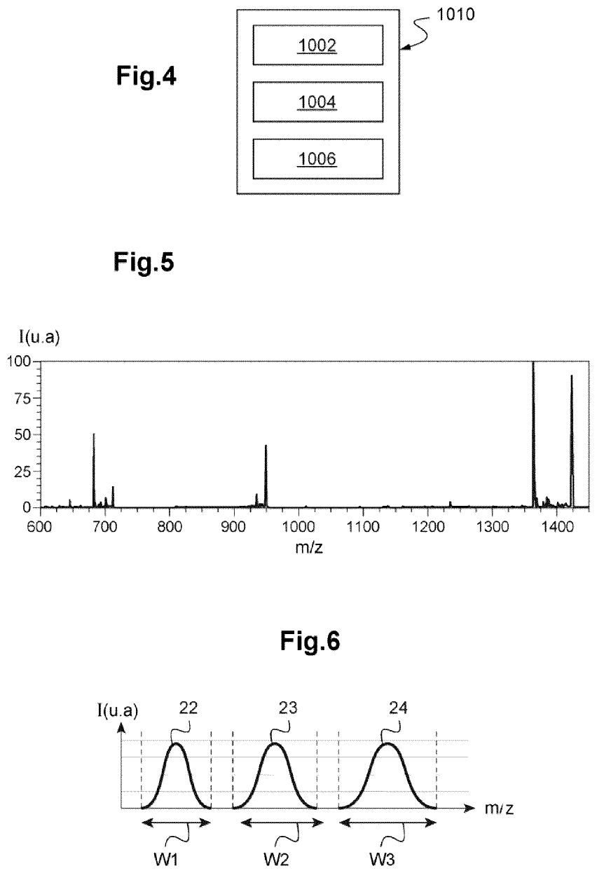

FIG. 4 is a schematic depiction of one embodiment of an acquisition step of a method according to the present disclosure;

FIG. 5 is one example of an average mass spectrum determined in an acquisition step of a method according to the present disclosure;

FIG. 6 is a schematic depiction of ranges of m/z ratio values determined based on an average mass spectrum obtained in an acquisition step of a method according to the present disclosure;

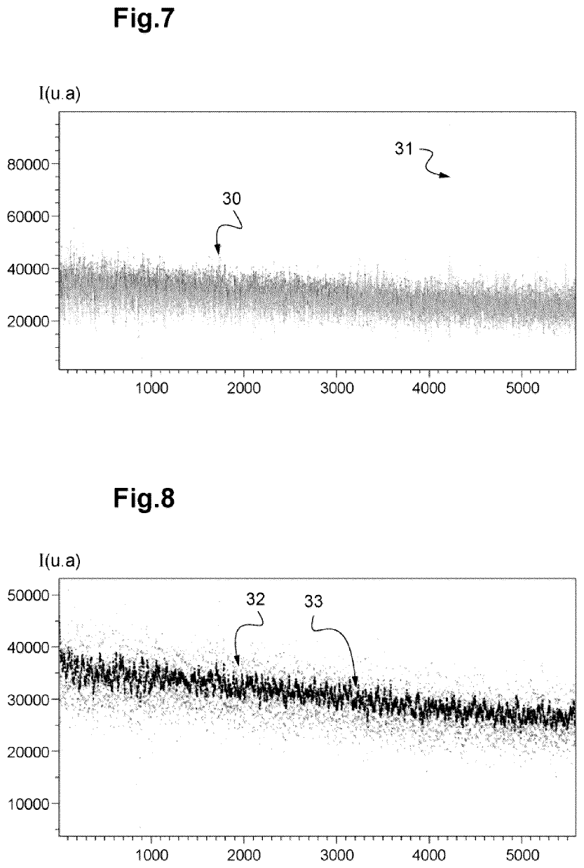

FIG. 7 is a depiction of one example of a first series of abundance values and a second series of abundance values obtained in an arrangement step of a method according to the present disclosure;

FIG. 8 is a depiction of the first series of abundance values and the second series of abundance values illustrated in FIG. 7, for which the abundance values of each of the series have been filtered by a Kalman filter in a method according to the present disclosure;

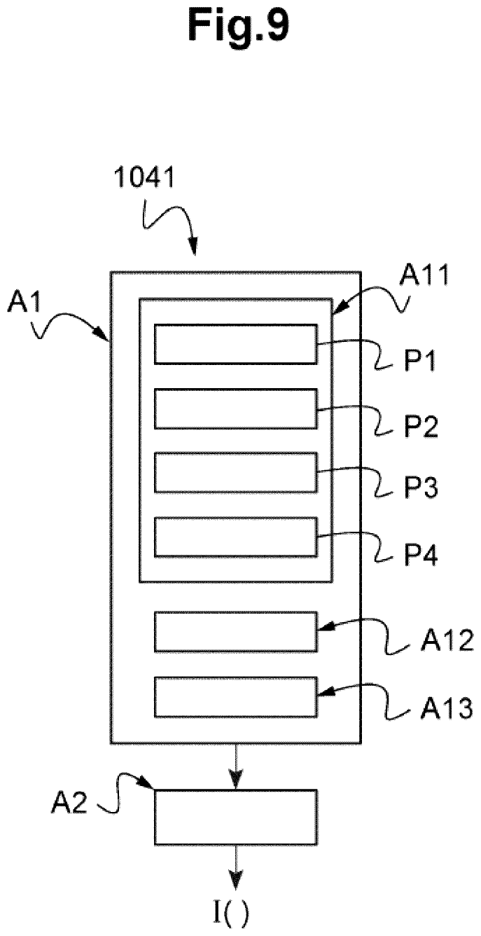

FIG. 9 is a schematic depiction of a determination step included in a step of calculating a correspondence score in a method according to the present disclosure, said score being based on calculation of mutual information;

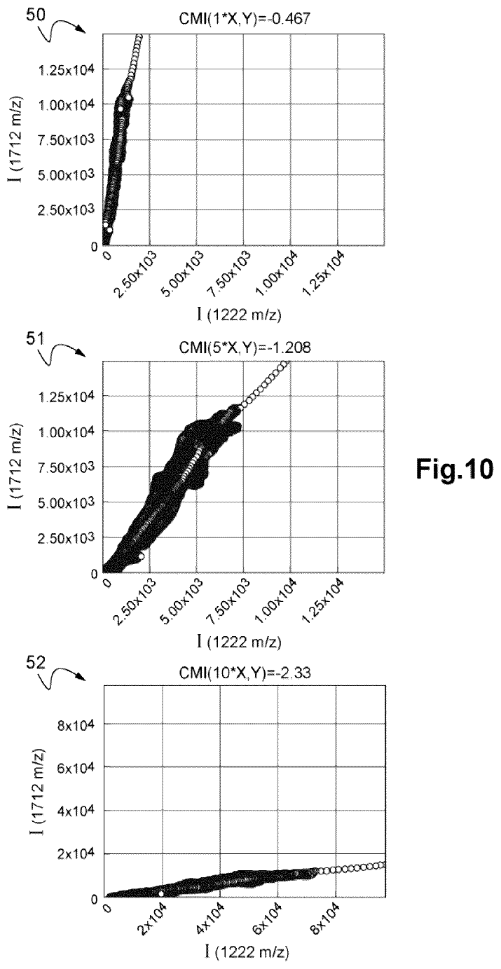

FIG. 10 is a succession of curves each illustrating a point cloud of a plurality of items of mutual information determined based on non-invariant entropies;

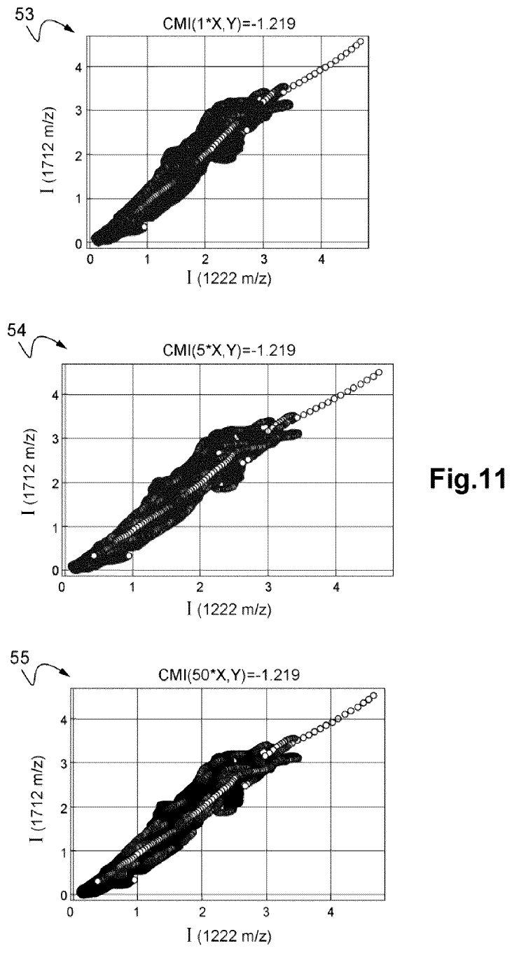

FIG. 11 is a succession of curves each illustrating a point cloud of a plurality of items of mutual information determined based on invariant entropies according to the present disclosure;

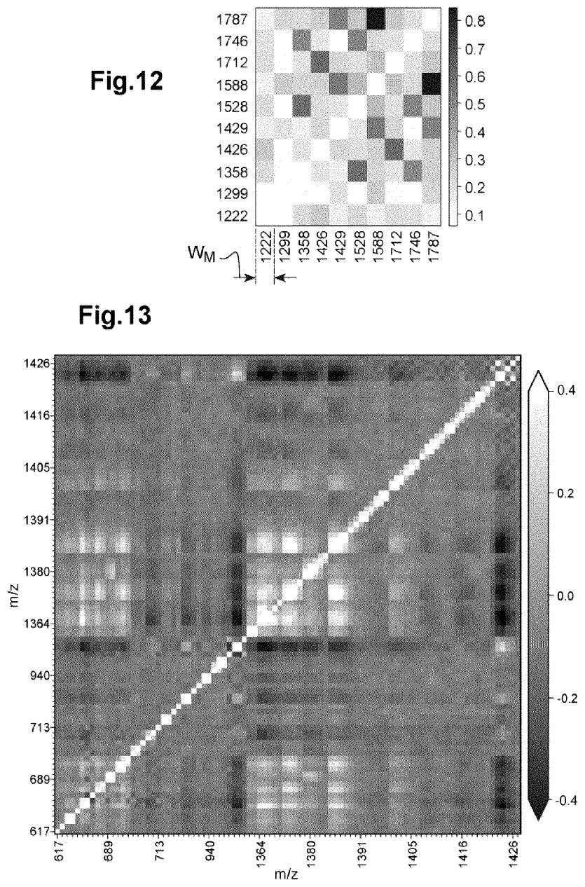

FIG. 12 is a score map obtained in a step of calculating a correspondence score based on mutual information by applying a method according to the present disclosure;

FIG. 13 is a score map obtained in a step of calculating a correspondence score based on a partial correlation by applying a method according to the present disclosure;

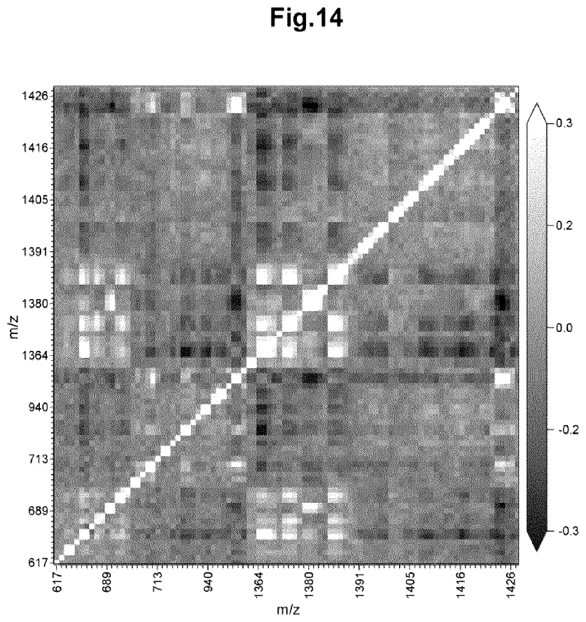

FIG. 14 is a score map obtained in a step of calculating a correspondence score based on a partial correlation by applying a method according to the present disclosure, the correlation scores being determined based on pairs of series of abundance values filtered by a Kalman filter;

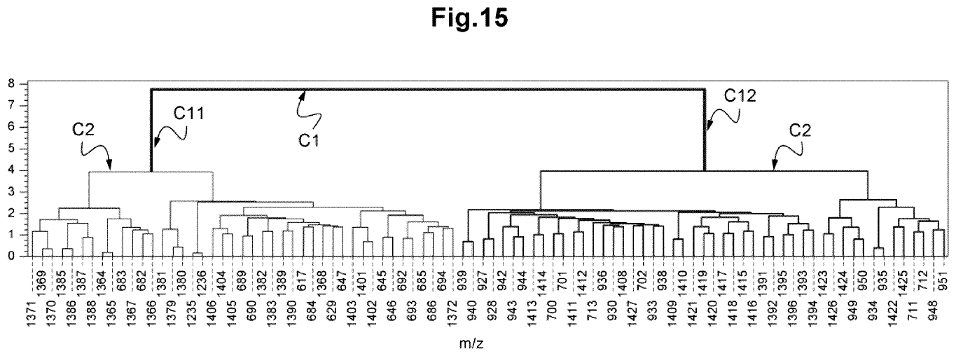

FIG. 15 is a schematic depiction of a dendrogram obtained by a clustering method used in a method according to the present disclosure;

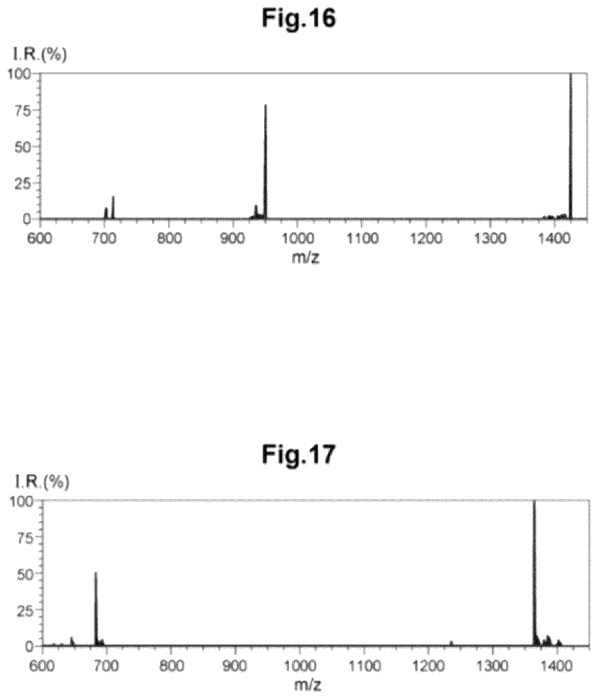

FIG. 16 is an exemplary depiction of an individual mass spectrum of a precursor ion of an ionized sample, said individual mass spectrum being obtained using a method according to the present disclosure;

FIG. 17 is an exemplary depiction of another individual mass spectrum of another precursor ion of an ionized sample, said individual mass spectrum being obtained using a method according to the present disclosure;

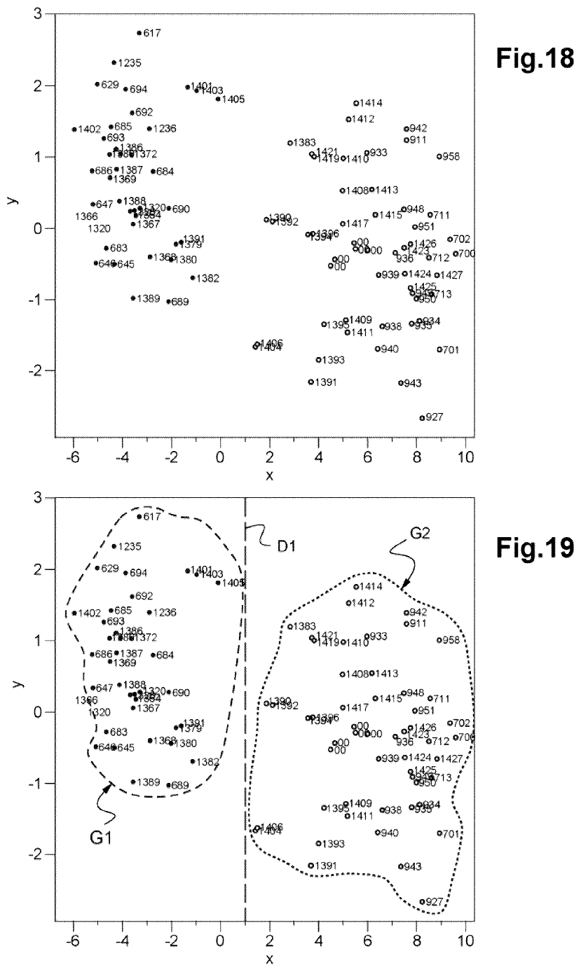

FIG. 18 is a schematic depiction of a two-dimensional map obtained using a clustering method used in a method according to the present disclosure;

FIG. 19 is a schematic depiction of the obtained two-dimensional map from FIG. 18 to which another clustering algorithm has been applied.

A description will be given, with reference to FIG. 1 and FIG. 2, of a device 100 for reconstructing a mass spectrum of an individual ion present in a sample according to the present disclosure.

The device illustrated in FIG. 1 comprises a measuring module 110 configured to determine at least one mass spectrum 2, preferably a plurality of mass spectra.

To this end, the measuring module 110 comprises a mass spectrometry device 10 as illustrated in FIG. 2. The mass spectroscopy device 10 may comprise a single-stage mass spectrometer device (as opposed to a tandem mass spectrometer).

In the example illustrated in FIG. 2, the mass spectroscopy device 10 is a single-stage device. It comprises an ionization source 11 for forming ions from the sample 1 to be analyzed and an activation means 12 configured to fragment the ions. In the present disclosure, the chemical composition of the sample is unknown. As a result, it comprises a mixture comprising one or more ions suspended in a solution. In other words, the sample may comprise various molecular species.

In the present disclosure, the sample 1 is for example a solution containing molecules. This sample 1 is then placed in the gaseous phase and is then ionized by the ionization source 11.

The ionization source 11 comprises at least one of the following ionization sources, namely: an electron impact ionization source, an electrospraying source, a chemical ionization source, a photoionization source, a laser ionization source, a matrix-assisted laser desorption/ionization source (known as MALDI source), a surface-enhanced laser desorption/ionization (SELDI) source, an atmospheric-pressure MALDI source, a matrix-assisted rapid ionization evaporation source, any other process involving a matrix or surface, any process involving a laser, a plasma ionization desorption source, an atmospheric-pressure chemical ionization source or an atmospheric-pressure photoionization source, an atmospheric-pressure ionization source.

In one preferred embodiment of the invention, the ionization source 11 comprises an electrospraying source. These ions are then activated by the activation means 12, which is configured to fragment the ionized ions in the gaseous phase in an in-source activation step (in-source CID). All of the ions are activated simultaneously and may produce electrically charged fragments or fragment ions, also called fragments in the remainder of the present disclosure.

In these various variants, the activation means 12 comprises at least one of the following means: collision activation, electromagnetic radiation absorption activation, thermal activation, etc.

In another embodiment, the mass spectrometry device 10 does not have an activation means 12. In this case, the ionization source may also be configured to fragment the ions of the sample. In other words, this type of ionization source 11 provides enough energy during ionization to produce fragments. In practice, such an ionization source 11 comprises for example an electron impact ionization source 11 or an ionization source 11 that uses laser desorption technology (LDI).

In another embodiment (not illustrated), the mass spectrometry device 10 comprises a first mass filter for selecting an m/z ratio range of interest, an activation means 12 and a second mass filter for analyzing fragmentation products resulting from the activation. In this embodiment, one or more precursors are selected and activated simultaneously. These ions will each produce one or more fragment ions. The recorded tandem mass spectrum therefore comprises all fragments generated and possibly the precursor ions. Such a mass spectroscopy device is also called a two-stage mass spectrometry device.

The ions obtained at the output of the activation means 12 are called ionized samples. They comprise in particular at least one ion, called a precursor ion.

In the present disclosure, a precursor ion or parent ion is the name given to an ion that may be decomposed into various fragments. Therefore, a fragment ion (or fragment) is a part or chemical structure of the parent ion.

The mass spectroscopy device 10 also comprises a mass filter 13 (also called an analyzer) that separates at least one precursor ion and also the various fragments of the ionized sample according to their m/z ratio.

In the present disclosure, the abundance of each ion may be used to obtain quantitative information about the concentration of the molecular species in the sample. The mass spectroscopy device 10 also comprises a detector 14 configured to detect ionized species (ionized ions). The mass spectrum 2 is obtained by recording the abundance of ions as a function of their mass-to-charge (m/z) ratio.

A mass spectrum 2 thus provides information about the chemical composition of the sample, in particular about the number of species present, typically ions and fragments, and about their respective mass.

As illustrated in FIG. 2, the mass spectroscopy device does not have a second mass filter required to carry out a tandem mass spectrometry measurement.

In the present disclosure, the mass spectrometry device 10 is also configured to acquire a timeseries of mass spectra 2. A timeseries is understood to mean that the mass spectrometry device 10 acquires mass spectra successively (in time). In practice, the sample 1 used to acquire these mass spectra 2 is identical for each acquisition of mass spectra 2 by the mass spectrometry device 10. However, the ionized sample of each acquisition (of mass spectra) may vary over the course of the acquisitions.

Optionally, the mass spectrometry device 10 may also comprise a computer (not illustrated) comprising a memory for storing the mass spectra acquired at the output of the detector.

The device 100 illustrated in FIG. 1 also comprises a processing unit 120.

A processing unit 120 is understood to mean a computer or processor or central processing unit (CPU) or any electronic device for implementing a succession of commands and/or calculations. Typically, the processing unit 120 comprises a processor, a memory and various input and output interfaces. To this end, the processing unit 120 is configured to control the operations and functions carried out by the device 100. The input and output interface may be the connection point allowing the device 100 to receive data and to send commands or data. The processing unit 120 may be connected to other processing units in order to exchange information therewith.

To this end, the processing unit 120 comprises one or more (calculation) modules configured to perform a succession of commands and/or calculations, which will be explained below with FIG. 3. Typically, the processing unit is configured to implement the method explained below.

The device 100 may also comprise a communication module 130 configured to exchange data with elements connected to the device 100 and/or elements internal to the device 100. Exchanging data is understood to mean sending and/or receiving data, the received data corresponding, in this example, to input data that may comprise a multitude of mass spectra, for example part of the series of mass spectra or the entire series of mass spectra acquired by the measuring module 110.

In this example, the communication module 130 receives the mass spectra determined by the measuring module 110 and stores them in the storage module 140.

Optionally in this example, the communication module 130 is connected to a database 4 external to the device 100. The database 4 typically comprises previously acquired mass spectra.

The database 4 is used in particular when the device 100 does not comprise a measuring device 110. Consequently, in this case, the device 100 does not directly measure mass spectra 2, but extracts mass spectra 2 that have been previously recorded from the database 4. Consequently, it is possible to work with previous mass spectra, with no measurement then being required. In this case, these received mass spectra (originating from the database 4) have preferably all been acquired by one and the same mass spectroscopy device 10.

In the considered example, the communication module 130 receives mass spectra 2 from the measuring device 110 (for example a series of mass spectra) and from the database 4. Similarly, these received mass spectra have been acquired by the same mass spectroscopy device 10. In other words, the mass spectra in the database have been previously acquired by the measuring device 110 and recorded in the database, external to the device 100. In one variant, this database is contained in the measuring device 110 (memory of the device 10) but remains different from the memory of the measuring device 110.

To receive the data from the database 4, the communication module 130 is also configured to be connected to at least one communication network 5, which may be a wireless communication network or a wired communication network. In practice, the wireless communication network uses at least one of the following technologies: Wi-Fi technology, Bluetooth technology, 2G/3G/4G/5G technology, etc. The wired communication network, for its part, uses ADSL technology, etc. Thus, in the device 100, the mass spectra measured by the measuring device 110 or extracted from the database 4 are received by the communication module 130, which transfers these data to the storage module 140 of the device 100.

The storage module 140 comprises for example a memory and/or a hard disk.

The storage module 140 stores in particular computer program instructions designed such that the processing unit 120 implements at least some of the steps of the method described below with reference to FIG. 3 when these instructions are executed by the processing unit 120.

All mass spectra received by the communication module 130 are concatenated to form a single series of mass spectra. This single series of mass spectra generally comprises at least 1000 mass spectra, preferably between 2000 and 8000 mass spectra in the purely stochastic case. It should be noted that all experimental conditions may vary between spectra of the same series: pressure, temperature, voltage, etc. It is enough for the abundance relationships between precursors and fragments to be preserved. On the contrary, experimental conditions in which there would no longer be any fragmentations do not allow the method to be applied. This is the only exclusion of the present method.

In addition, if external abundance disturbances are applied (for example variations in concentrations due to chromatographic separation, ion mobility separation, or any other disturbance such as for example discriminant transmission of ion optics), then the number of measurements required is reduced compared to the stochastic case. In the non-stochastic case in which an external disturbance modifies or modulates the abundances of ions, the number of mass spectra may be reduced to 5 spectra in order to form a series of measurements able to be used on a reduced number of acquisitions.

Thus, the mass spectra measured by the measuring device and/or the mass spectra extracted from the database 4 are concatenated in the storage module 140 so as to form a plurality of mass spectra.

The storage module 140 thus stores this plurality of mass spectra.

Preferably, the plurality of mass spectra is a timeseries of mass spectra. In other words, all mass spectra of the series of mass spectra are measured by one and the same mass spectroscopy device 10 for one and the same sample 1. Such a configuration has the advantage of obtaining a series of mass spectra that is more precise as it is acquired directly with one and the same mass spectroscopy device 10. In one variant, the series of mass spectra may be acquired by multiple similar mass spectrum devices 10 and under similar measurement conditions. This has the advantage of being faster to obtain the series of mass spectra.

FIG. 3 shows one example of a method implemented by the device 100.

This method 1000 is a method for reconstructing a mass spectrum of at least one precursor ion based on a plurality of mass spectra measured on the ionized sample comprising at least one precursor ion and fragment ions.

In practice, the method 1000 is computer-implemented, for example by being implemented by the device 100 illustrated in FIG. 1.

The method 1000 may also be implemented in microcontrollers or programmable gate arrays (for example FPGA).

This method 1000 comprises a step 1010 of acquiring a series of mass spectra on the ionized sample comprising at least one precursor ion and fragment ions. In the present disclosure, acquisition is understood to mean directly measuring mass spectra and/or receiving mass spectra.

To this end, the acquisition step 1010 comprises an (optional) preliminary step 1001 for recovering the plurality of mass spectra. In practice, the preliminary step 1001 begins with a step 1002 of measuring mass spectra by way of the measuring unit 110 of the device 100 and/or a step 1004 of receiving mass spectra from the database 4. One example of a preliminary step is illustrated in FIG. 4. In this example, the preliminary step comprises the step 1002 of measuring mass spectra by way of the measuring unit 110 and the step 1004 of receiving mass spectra from the database 4. In this example, all these mass spectra (originating from the measuring module 110 and the database 4) are concatenated in a concatenation step 1006 in the memory module 4 so as to form the plurality of mass spectra of the at least one precursor ion and the fragment ions.

This plurality of mass spectra (or series of mass spectra) is then detected and acquired 1008, by the processing unit 120 of the device 100, in order to reconstruct a mass spectrum of at least one precursor ion based on this series of mass spectra.

The method 1000 illustrated in FIG. 3 then optionally comprises a step 1015 of processing the acquired plurality of mass spectra. Typically, the processing unit 120 processes all mass spectra of the plurality of mass spectra.

Various processing operations may be implemented on the mass spectra of the series of mass spectra. The processing operations comprise at least one of the processing operations below:
smoothing, for example using a Savitzky-Golay algorithm with a baseline correction algorithm, etc.;
normalization, for example by dividing each acquired mass spectrum by a constant a dependent on the acquired mass spectrum. In practice, the constant a corresponds to the abundance (intensity) of a peak of the mass spectrum, in particular the abundance of the most intense peak (that is to say the peak with the highest intensity). Thus, for normalization, each peak of the given mass spectrum is divided by the abundance of the most intense peak of the mass spectrum;
a peak picking algorithm;
elimination or filtering, for example using a signal-to-noise ratio to remove irrelevant mass spectra;
deisotoping,
clustering of data, for example using techniques known as binning;
filtering, for example by convoluting each spectrum with a particular kernel.

Without limitation, the processing unit 120 may filter each mass spectrum of the plurality of mass spectra in order to attenuate noise on each spectrum related to the measurement of these mass spectra that may impact the abundances of the m/z ratios. Here, typically, the processing unit 120 determines the signal-to-noise ratio of each mass spectrum of the plurality of mass spectra and eliminates for example mass spectra comprising a signal-to-noise ratio less than or equal to 0.5.

The processing step 1015 may also comprise a compressed acquisition processing operation, also known as compressed sensing. This processing operation may be carried out as an alternative to the processing operations listed below or in combination therewith.

After filtering, the processing unit 120 normalizes each mass spectrum of the acquired plurality of mass spectra. For this purpose, for each mass spectrum, the processing unit 120 determines the peak having a maximum abundance (for example via the peak picking algorithm) and then divides the abundances of the other peaks of the given mass spectrum by the previously determined maximum value. The normalization constant a varies from one mass spectrum to another.

After normalization, the processing unit 120 is able to carry out peak alignment processing to select ranges of given m/z ratios. This has the advantage of working thereafter on only some of the mass spectra of the series of mass spectra.

Following the processing step 1015 (if present in the method 1000), the method 1000 then comprises a step 1020 of determining a plurality of series of abundance values of the ionized sample. In practice, in the determination step 1020, a series of abundance values of the at least one precursor ion and a series of abundance values of each fragment ion are determined. In the present disclosure, each series of abundance values comprises N abundance values, where N is an integer greater than or equal to two. In practice, each integer assigned from 1 to N corresponds to a mass spectrum of the plurality of mass spectra.

In a first variant, the determination step 1020 may be implemented by the processing unit 120 as follows. For example, the processing unit 120 runs through each mass spectrum used as input datum for the determination step 1020 and, for each mass spectrum, retrieves and records an abundance value for each m/z ratio, thus creating a series of abundance values (that is to say equivalent to a list of abundance values) for each m/z ratio of the mass spectra of the plurality of mass spectra. A series of abundance values is understood here to mean a succession of abundance values obtained based on one and the same given m/z ratio. Thus, typically, for a given m/z ratio, each value of the series of abundance values corresponds to an acquisition (that is to say a measurement), that is to say to a given mass spectrum N. There are therefore, in a series of abundance values, as many abundance values as there are mass spectra used in the determination step 1020. In this example, there are therefore as many series of abundance values as there are m/z ratios detected in the mass spectra of the series of mass spectra. Each series of abundance values is typically recorded in the memory of the processing unit 120 and/or in the storage module 140.

In a second variant, the abundance series values correspond to abundance values integrated over a range of m/z ratio values.

To obtain this type of series of abundance values, the processing unit 120 may first calculate an average mass spectrum based on the plurality of mass spectra by averaging the abundance values for each m/z ratio of the mass spectra of the plurality of mass spectra. An average spectrum is therefore obtained.

For example, FIG. 5 illustrates an average mass spectrum obtained based on the plurality of mass spectra acquired based on a sample comprising melittin and a substance P. The average mass spectrum illustrated in FIG. 5 was obtained based on a plurality of mass spectra. The plurality of mass spectra were each obtained by electrospraying a mixture comprising melittin and substance P in solution in a mixture of water and methanol at a concentration of 10⁻⁵ mol/1. For example, the mixture was activated by ultraviolet radiation of 20 eV for 500 ms to provide the ionized sample.

The processing unit 120 may then determine ranges of m/z ratio values based on the average mass spectrum, for example by detecting peaks in the average mass spectrum and by calculating, for each peak (22, 23, 24), an interval of m/z ratios comprising at least the given peak.

For example, FIG. 6 shows a schematic depiction of an average mass spectrum obtained based on the N mass spectra of the plurality of mass spectra. In particular in this example, each interval W1, W2, W3 covers all abundance values of the given peak 22, 23, 24, and may also cover m/z ratio values around the given peak. A range of m/z ratio values thus corresponds to some of the m/z ratios of the average mass spectrum. In this example, three ranges W1, W2 and W3 of m/z ratio values are detected by the processing unit. In this variant, a range W of m/z ratios is associated with a peak of the average mass spectrum. These ranges of m/z ratio values are then recorded. The processing unit 120 may create a series of ranges of m/z ratio values of size N×M, with N corresponding to the number of mass spectra of the plurality of mass spectra (here an integer greater than 2) and M corresponding to the number of ranges of m/z ratio values (here an integer greater than 2) and that comprises, in the example of FIG. 6, three elements (the ranges W1, W2, W3). In practice, the M ranges of m/z ratio values are similar for each mass spectrum N, thereby making it possible to integrate all mass spectra in a similar manner.

Subsequently, the processing unit 120 may, for each mass spectrum, integrate abundance values over given parts of each mass spectrum, each given part corresponding to a previously determined range of m/z ratio values. Typically, for a mass spectrum N, the given mass spectrum is integrated over various ranges of values defined by the M ranges of values of the series of ranges of m/z ratio values at the coordinate N of the series of ranges of m/z ratio values.

An integrated abundance value is therefore obtained for each determined range of m/z ratio values. The abundance values integrated over one and the same range of m/z ratio values over the whole plurality of mass spectra makes it possible to obtain a series of abundances of an ion or fragment ion. Thus, based on all ranges of m/z ratio values, series of abundance values are obtained.

In this embodiment, each series of abundance values is subsequently associated with a specific m/z ratio within the considered range of m/z ratio values. The specific m/z ratio may correspond to the median value of the m/z ratio of the range of m/z ratio values, or preferably to the m/z ratio associated with a maximum abundance value of the average mass spectrum over the given range of m/z ratio values. Thus, according to this variant, each abundance series is associated with a peak of the average spectrum. Fewer series of abundance values are therefore calculated in this variant, thereby improving the speed of the method 1000. Moreover, since each series of abundance values is calculated over a range of m/z ratios defined on the basis of a peak of the average spectrum, each series of abundance values may be considered to correspond to an ion of the ionized sample.

Moreover, integrating the abundance values of the sample makes it possible to associate ions of the ionized sample belonging to one and the same isotopic distribution. When the resolution allows, the isotopes are separated, but it is desired to group them together as a single ion. Of course, this second variant, which may correspond to a step of grouping the isotopes together (deisotoping), may be carried out using other algorithms known to those skilled in the art.

In practice, the series of abundance values determined in the determination step 1020 may be recorded and grouped together in one and the same file.

The method 1000 optionally comprises a step 1025 of processing the series of abundance values, comprising at least one of the following calculations:
filtering the given series of abundance values by way of a Kalman filter;
filtering the given series of abundance values by way of a Fourier filter;
filtering the given series of abundance values by way of a moving average.

Such a step 1025 makes it possible to remove noise from the abundance values of the series of abundance values. For example, in the integration over the intervals (second variant of the determination step 1020), the processing unit 120 may apply a temporal filter to each interval. This has the advantage of attenuating noise throughout the acquisition, and of highlighting temporal variations. Typically, the Kalman filter may be preferred to remove integration noise. Typically, FIG. 8 illustrates one example comprising a series of abundance values 32 of an ion and a filtered series of abundance values 33 of this same ion, filtered here by a Kalman filter. It may be seen that the abundance values of the filtered series 33 fluctuate less. The signal is more stable.

Thereafter, the method 1000 comprises a step of arranging 1030 the plurality of series of abundance values into pairs of series of abundance values, each pair of series of abundance values comprising a first series of abundance values (denoted X) and a second series of abundance values (denoted Y).

In practice, the processing unit 120 retrieves one series of abundance values of the plurality of series of values and combines it with another series of abundance values of the plurality of series of abundance values. Preferably, there may be as many combinations as there are series of abundance values. Thus, for P determined series of abundance values (with P an integer greater than 2, P² pairs of series of abundance values are determined by the processing unit 120, considering that a series of abundance values may form a pair of series of abundance values with itself).

FIG. 7 illustrates a pair of series of abundance values consisting of a first series of abundance values 30 associated, in this example, with an m/z ratio of 1365 and a second series of abundance values 31 associated, in this example, with an m/z ratio of 1424. Here, N corresponds to 5532.

The method 1000 also comprises, for each pair of series of abundance values, a step 1040 of calculating a correspondence score between the first series of abundance values and the second series of abundance values. This correspondence score is therefore calculated for all pairs of series of abundance values. The set of correspondence scores obtained for all pairs of series of abundance values provides a score map, which is typically a symmetrical matrix of size P×P.

In practice, the correspondence score is based on at least one of the following elements:
mutual information between the first series of abundance values and the second series of abundance values, said mutual information being based on an entropy of the first series of abundance values and on an entropy of the second series of abundance values;
a correlation between the first series of abundance values and the second series of abundance values.

The correspondence score determined in the calculation step 1040 is based on one of the abovementioned cases or on a mixture of the abovementioned cases. However, the score map is composed of correspondence scores of the same type, that is to say calculated in the same way using the same calculation method.

Of course, the processing unit 120 may calculate various correspondence scores, for example a score based on the mutual information, a score based on a correlation and a score based on the mutual information and on the correlation previously calculated.

The various correspondence scores able to be determined in the calculation step 1040 will be explained below.

These examples of correspondence scores are determined for each pair of previously recorded series of abundance values. For the sake of simplification, the calculations described below describe an application of the calculation step 1040 to a single pair of series of abundance values.

### Mutual Information

In this variant, the calculation step 1040 comprises a step of determining the mutual information 1041. Various embodiments of the step of calculating the mutual information will be described below.

FIG. 9, FIG. 10, FIG. 11 and FIG. 12 illustrate one embodiment in which the correspondence score is based on mutual information (mathematics). In this embodiment, the mutual information is determined by an information theory method, to be described below, that uses entropy calculations.

### Mutual Information Between Two Variables

In a first embodiment of step 1041, the mutual information between two variables is defined by the following formula:

$$I ( X , Y ) = h ( X ) + h ( Y ) - h ( X , Y ) \qquad [ Math . 1 ]$$

with X corresponding to a first variable (here, for example, it may correspond to the first series of abundance values defined for an ion of the ionized mixture, the ion possibly being a precursor ion or a parent ion) and Y corresponding to a second variable (here, for example, it may correspond to the second series of abundance values defined for an ion of the ionized mixture).

Here, h( ) corresponds to the entropy (also called intrinsic entropy) defined for a given random variable expressed by the mathematical function:

$$h ( X ) = {\int }_{X} {μ}_{X} ( x ) log ( {μ}_{X} ( x ) ) dx \qquad [ Math . 2 ]$$

where μₓ(x) corresponds to the probability density function of the continuous random variable X (corresponding to the probability of a signal appearing in the variable X) (here the abundance values of each considered acquisition).

Entropy h( ) may also be written, for non-continuous variables, by the following formula:

$$h ( X ) = - {\sum }_{i = 1}^{n} {P}_{i} * {log}_{2} ( {P}_{i} ) ,$$

with Pi corresponding to the probability of a signal appearing in the variable X.

The density law μₓ cannot be calculated directly with a finite number of points as in the present example. Indeed, it is not possible to know the density law μₓ. It is therefore necessary to approximate the magnitude h( ) by way of an estimate. The two methods most commonly used to estimate h( ) are:
the histogram method, which consists in dividing a series of points into various equal intervals. Each interval contains a number of points ni, i being the ith interval, and a probability pi=ni/N is associated, where N is the total number of points. A continuous variable is thus approximated as a discrete variable, and the formula set out in the paragraph above is used. This method is invariant, but requires a large number of points to approach the theoretical limit by analogy with a Riemann integral. In addition, the number of intervals chosen provides a bias on the final estimate.
the knn (k-nearest neighbors) method, which derives its origin from the median point method used to numerally calculate an integral. This method is not invariant, but the entropy estimate converges faster than the histogram method, and therefore requires fewer points. The final estimate using this method is given below.

Thus, to determine the correspondence score of each pair of series of abundance values, the processing unit 120 estimates (in an estimation step A1 of the step 1041 of determining the mutual information), for each pair, the entropy of the first series of abundance values and the entropy of the second series of abundance values using an estimation algorithm. These estimated entropies are denoted H.

A description will be given of the estimation step A1 according to the present disclosure.

In the present disclosure, an equivalence is sought between the entropy h( ) and the estimated entropy H( ).

In practice, the entropy estimated at a variable X (corresponding here for example to the first series of abundance values) is expressed according to the formula:

$$H ( X ) = d * average ( log ( distance ( L ) ) + log ( V ) + psi ( n ) - psi ( L ) \qquad [ Math . 3 ]$$

with d corresponding to the dimension of the variable X (here equal to 1), log (distance( )) corresponding to all values of the distances determined by the k-nearest neighbors estimation algorithm (the calculation of this distance is expressed below), n corresponding to the number of abundance values in the series of abundance values (here, n is equal to N), L corresponding to the number of neighbors considered in the estimation algorithm (here equal to 1 for example when the distance is determined for a single neighbor), psi( ) corresponding to a Digamma function that may be expressed by

$$psi ( x ) = {Γ ( x )}^{- 1} \frac{dΓ}{dx}$$

and that may satisfy a recursion psi(x+1)=psi (x)+1/x, with psi(1)=−C for C=0.5777 being the Euler-Mascheroni constant, V corresponding to a volume of a unit hypersphere expressed according to the following formula:

$${V}^{( n )} [ r ] = \frac{{π}^{\frac{n}{2}} {r}^{n}}{Γ ( \frac{n}{2} + 1 )} \qquad [ Math . 4 ]$$

with r the radius of the hypersphere (equal to 1), a Γ gamma function being able to be expressed by Γ:

$$x \to {\int }_{0}^{+ ∞} {e}^{- t} {t}^{x - 1} dt .$$

The k-nearest neighbors algorithm makes it possible to calculate all distances between all points. Thus, distance(L) is a series of N values, where the i^{th} value of the series corresponds to the L^{th} smallest distance from the i^{th} point.

Various methods may be used to estimate the entropy of the first series of abundance values and the second series of abundance values. In particular, the processing unit 120 may use at least one of the following methods: a method based on histograms, a method based on a k-nearest neighbors algorithm, a kernel density estimation method, etc.

In practice, in the present disclosure, the processing unit 120 may use a k-nearest neighbors (kNN) algorithm to estimate the entropy H of a given series of abundance values used in the calculation of the mutual information. The kNN algorithm is chosen because this method is robust, compared to an estimation method using a histogram, and works on small samples.

Typically, the kNN algorithm uses a distance calculation between abundance values of one and the same series to approximate the probability density of the series.

In practice, the k-nearest neighbors method uses a Euclidean distance to estimate the joint entropy between the data (abundance values) of the first series of abundance values and the data of the second series of abundance values.

In this example, the Euclidean distance used depends on the first series of abundance values and on the second series of abundance values in question, in particular on the processing operations that may have been carried out in the processing step 1015.

Hereinafter, two consecutive abundance values of the first series of abundance values (associated with an ion) are denoted by A=(xᵢ, xᵢ₊₁) and two consecutive abundance values of the second series of abundance values (associated with an ion) are denoted by B=(yᵢ, yᵢ₊₁), with xᵢ an abundance value of the first series of abundance values for an acquisition i, with xᵢ₊₁ an abundance value of the first series of abundance values for an acquisition+1, with yᵢ an abundance value of the second series of abundance values for an acquisition i and with yᵢ₊₁ an abundance value of the second series of abundance values for an acquisition+1.

In practice, when no normalization is calculated in the processing step 1015 or when the method 1000 does not comprise a processing step 1015, the Euclidean distance between the abundance values of a first series of abundance values and the abundance values of the second series of abundance values is expressed by the formula:

$$d ( A , B ) = \sqrt{{( {x}_{i} - {x}_{i + 1} )}^{2} + {( {y}_{i} - {y}_{i + 1} )}^{2}} = {d}_{AB} \qquad [ Math . 5 ]$$

with A a variable (that is to say data corresponding here to the first series of abundance values (A=X)), B a variable (that is to say data corresponding here to the second series of abundance values (B=X)), xᵢ a variable corresponding to a signal of A (therefore here to an abundance value contained in the first series of abundance values at acquisition i, that is to say an abundance value of an ion of the ionized sample), xᵢ₊₁ corresponding to the signal following xᵢ (therefore the abundance value of the ion at acquisition+1), yᵢ a variable corresponding to a signal of B (therefore here to an abundance value contained in the second series of abundance values at acquisition i, that is to say an abundance value of another ion of the ionized sample), and yᵢ₊₁ corresponding to the signal following yᵢ (therefore corresponding to an abundance value of the other ion at acquisition+1).

In the case of normalization of the mass spectra in the processing step 1015, the Euclidean distance defined by the formula Math. 5 does not apply. Therefore, the entropy h( ) is not directly equivalent to the entropy H( ) estimated by the estimation algorithm.

Indeed, entropy with regard to a variable X (here the variable X corresponds to a series of abundance values of an ion contained in the pair of abundance series) has two major drawbacks in opposition to discrete entropy. The first drawback is that it is not invariant after a change of variable, as described by the following formula:

$$h ( kX ) = h ( X ) + log ( \vert k \vert ) \qquad [ Math . 6 ]$$

with k a multiplicative constant, X a variable corresponding here to an abundance series of an ion (for example a precursor ion), and h corresponding to the entropy of the variable X. And the second drawback is that entropy according to the definition [Math. 2] may be negative.

Invariant entropy thus corrects the possible negativity of entropy and the dimension problem after a change of variable. This entropy is expressed by the mathematical function: h(x)=−∫_{X}μ_{X}(x)log(μ_{X} (x)/m (x))dx and is estimated, in the same way as the equation [Math. 2], by the knn method on the series of values X divided by the invariant measure m(X).

In this variant, when estimating the entropy of the first series of abundance values and of the second series of abundance values based on data that have been normalized by one and the same normalization constant, denoted k (for example, when a=k), entropy is also invariant by multiplication by a multiplicative constant k (here k=a), as described by the following formula:

$$h ( kX , kY ) = h ( X , Y ) + log ( {k}^{2} ) \qquad [ Math . 7 ]$$

with k a multiplicative constant, X a variable corresponding in this case to the first series of abundance values, and Y a variable corresponding in this case to the second series of abundance values.

Similarly, the equation Math. 7 does not apply directly when the multiplicative constant of the first series of abundance values is different from that of the second series of abundance values, for example when the normalization constant that was used to determine the data of the first series of abundance values is different from the one used to determine the data of the second series of abundance values.

Thus, in the case of normalization in the processing step 1015, in order to have an equivalence between the entropy h( ) and the estimated entropy H, it is necessary to work based on invariant entropy and invariant estimated entropy.

Invariant is understood to mean that the considered entropy, for example the entropy estimated over a given series of abundance values (H(X), with X the given series of abundance values), is equal to the estimated entropy calculated over the same series of abundance values multiplied by a constant (H(kX), with X the given series of abundance values and k the multiplicative constant, which may be equal here to the normalization constant used in the processing step 1015).

To obtain such equivalence, the entropy estimated based on the first series of abundance values used when calculating the two-variable mutual information is normalized by a first invariance parameter, and the entropy estimated based on the second series of abundance values used when calculating the two-variable mutual information is normalized by a second invariance parameter.

In practice, the processing unit 120 uses, for a given series of abundance values, the invariant parameter m(X) (also called invariant measure) defined according to the following three properties:

$$\begin{matrix}i ) m ( X ) = {r}_{x} > 0 ; \\ ii ) m ( kX ) = k m ( X ) = {kr}_{X} \\ iii ) m ( X + b ) = m ( X ) = {r}_{X} .\end{matrix}$$

with X the considered series of abundance values, m(X) the invariant measure of the considered series of abundance values, rₓ>0 being a median value of all distances between each pair of closest abundances of the considered series, k a chosen multiplicative constant (which may depend on the normalization constant a in the processing step) and b an additive constant the value of which may for example depend on noise (for example noise contained in the abundance values of the series of abundance values).

Using the properties defined above, it is possible to obtain an equivalence between the entropy h( ) and the estimated entropy H( ), such that:

$$h ( X ) = H ( \frac{X}{m ( X )} ) \qquad [ Math . 8 ]$$

with X a given series of abundance values, h the intrinsic entropy, H the estimated entropy determined in the calculation step, and m(x) the invariant measure. (It should be noted that the property of invariance also permits the equivalence

$$H ( X ) = h ( \frac{X}{m ( X )} ) . )$$

The formula Math. 8 may be generalized to entropy between multiple variables, typically when multiple series of abundance values are extracted from the plurality of mass spectra. In other words, this is used in particular when multiple series of abundance values of ionized ions and/or ionized ion fragments are to be taken into account. In this case, the equivalence of the formula Math. 8 may be generalized in n dimensions (n=N):

$$h ( X , Y , … , Z ) = H ( \frac{X}{m ( X )} , \frac{Y}{m ( Y )} , . … . , \frac{Z}{m ( Z )} ) \qquad [ Math . 9 ]$$

with X, Y . . . Z corresponding to the series of abundance values of the given ion X or Y or Z.

The equivalence sought for an entropy calculated between two variables is thus written as follows:

$$h ( X , Y ) = H ( \frac{X}{m ( X )} , \frac{Y}{m ( Y )} ) \qquad [ Math . 10 ]$$

with X and Y two series of abundance values, where X is associated hereinafter with the first series of abundance values belonging to a given pair of series of abundance values (here corresponding to a series of abundance values of an ion of the ionized sample) and Y is associated with the second series of abundance values belonging to the same pair (here corresponding to a series of abundance values of another ion of the ionized sample), m(X) corresponding to the first invariance parameter of the series X (that is to say invariance parameter of the first series of abundance values) and m(Y) corresponding to the second invariance parameter of the series Y (that is to say invariance parameter of the second series of abundance values), h entropy and H estimated entropy.

Based on the above properties, when the multiplicative constant of the first series of abundance values (here A=X) is identical to the multiplicative constant of the second series of abundance values (here B=Y), the Euclidean distance used in the step 1041 of determining the mutual information may also be expressed by the following formula: [Math. 11]

$$d ( kA , kB ) = \sqrt{{( {kx}_{i} - {kx}_{i + 1} )}^{2} + {( ky - {ky}_{i + 1} )}^{2}} = {kd}_{A B} . \qquad [ Math . 11 ]$$

Specifically, by multiplying the first series of abundance values and the second series of abundance values by one and the same multiplicative constant (k), the abundances in each acquisition of the first series of abundances are written kA=(kxᵢ, kxᵢ₊₁) and the abundances in each acquisition of the second series of abundances are written kB=(kyᵢ, kyᵢ₊₁). Typically, k may be a negative or positive number.

When the multiplicative constant of the first series of abundance values (here denoted a₁) is not identical to the multiplicative constant of the second series of abundance values (here denoted a₂), the Euclidean distance used in the determination step 1041 may also be expressed by the following formula:

$$d ( {a}_{1} A , {a}_{2} B ) = \sqrt{{( {a}_{1} {x}_{i} - {a}_{1} {x}_{i + 1} )}^{2} + {( {a}_{2} y - {a}_{2} {y}_{i + 1} )}^{2}} \qquad [ Math . 12 ]$$

with a₁ the multiplicative constant of the first series of abundance values and a₂ the multiplicative constant of the second series of abundance values. Similarly, a1 and a2 are two constants that may be negative or positive.

To calculate such a distance d(a₁A, a₂B), the processing unit 120 may carry out a variable change by setting:

$${A}^{′} = \frac{A}{{r}_{x}} \qquad [ Math . 13 ]$$

$${B}^{′} = \frac{B}{{r}_{y}} \qquad [ Math . 14 ]$$

With the formulas Math. 13 and Math. 14, the following equations are obtained:

$${a}_{1} {A}^{′} = \frac{{a}_{1} A}{{r}_{{a}_{1} x}} = \frac{{a}_{1} A}{{a}_{1} {r}_{x}} , and \qquad [ Math . 15 ]$$

$${a}_{2} {B}^{′} = \frac{{a}_{2} B}{{r}_{{a}_{2} y}} = \frac{{a}_{2} B}{{a}_{2} {r}_{y}} , and \qquad [ Math . 16 ]$$

$${A}^{′} = ( \frac{{x}_{i}}{{r}_{x}} , \frac{{x}_{i + 1}}{{r}_{x}} ) , and \qquad [ Math . 17 ]$$

$${B}^{′} = ( \frac{{y}_{i}}{{r}_{y}} , \frac{{y}_{i + 1}}{{r}_{y}} ) . \qquad [ Math . 18 ]$$

The processing unit 120 thus uses the formulas described above to define, in its estimation algorithm, the Euclidean distance according to the formula described below:

$$d ( {a}_{1} {A}^{′} , {a}_{2} {B}^{′} ) = \sqrt{{( \frac{{a}_{1} {x}_{i}}{{a}_{1} {r}_{x}} - \frac{{a}_{1} {x}_{i + 1}}{{a}_{1} {r}_{x}} )}^{2} + {( \frac{{a}_{2} {y}_{i}}{{a}_{2} {r}_{y}} - \frac{{a}_{2} {y}_{i + 1}}{{r}_{y}} )}^{2}} \\ d ( {a}_{1} {A}^{′} , {a}_{2} {B}^{′} ) = {( \frac{{x}_{i}}{{r}_{x}} - \frac{{x}_{i + 1}}{{r}_{x}} )}^{2} + {( \frac{{y}_{i}}{{r}_{y}} - \frac{{y}_{i + 1}}{{r}_{y}} )}^{2} = d ( {A}^{′} , {B}^{′} ) . \qquad [ Math . 19 ]$$

A description will now be given of how the processing unit 120 determines the invariance parameter of the two series of abundance values of each pair of series of abundance values (step of determining the invariance parameter A11 of each series of the pair of series considered in the estimation step A1).

As explained above, each invariant measure is associated with a series of abundance values. The processing unit 120 therefore determines an invariant measure (step A11) for each previously determined series of abundance values. This invariant measure, as explained above, depends on the abundance values of the series of abundance values.

In practice, the invariant measure may be determined upstream of the determination estimate 1041, for example following the determination step 1020.

A description will therefore be given of one example of a step of determining an invariance parameter over a first series of abundance values and an invariance parameter over a second series of abundance values (step A11).

For a given series of abundance values (for example the first series of abundance values), the processing unit 120 calculates (step P1) all differences between the abundance values contained in the series of abundance values. For this purpose, the processing unit 120 runs through the series of abundance values and calculates, for each abundance value, a difference from all other abundance values of the series of abundance values. N−1 differences are thus determined for each abundance value of the series of abundance values. For example, a list of difference values is recorded for each abundance value.

The processing unit 120 then, for each abundance value of the series of abundance values, searches for the smallest difference between this abundance value and another abundance value contained in the series of abundance values (step P2). For this purpose, the processing unit runs through the list of differences associated with the given abundance value and searches for the smallest difference obtained in the list of differences associated with this abundance value. Each abundance value is therefore associated with a minimum distance. N minimum distances are thus determined for this given series of abundance values. These minimum distances are then arranged in ascending order.

The processing unit 120 then determines a median based on these N minimum distances (step P3), and then multiplies this median value by the number N of abundance values of the given series of abundance values (step P4). This last calculated value is then assigned to the invariance parameter (here the first invariance parameter) of the given series.

These steps are also performed on the other series of the pair of mass spectra (for example on the second series) in order to obtain the second invariance parameter.

The step of determining the invariance parameter A11 thus provides an invariance parameter for each series of abundance values. The invariance parameter complies with the three properties i), ii) and iii) explained above.

The estimation step A1 comprises a step (step A12) of normalizing each series of abundance values by its invariance parameter. Thus, for example, in this step, the processing unit 120 divides each abundance value of the considered series of abundance values by the invariance parameter determined over this series. Hereinafter, the normalized first series of abundance values is denoted

$$\frac{X}{m ( X )}$$

for the first series of abundance values and the normalized second series of abundance values is denoted

$$\frac{Y}{m ( Y )}$$

for the second series of abundance values.

After the normalization step, each series of abundance values is therefore normalized.

The entropy estimate in the estimation step carried out on the pairs of mass spectra uses these normalized series of abundance values.

Thus, in the method 1000, in the estimation step A1 (contained in the step 1041 of determining the mutual information), the processing unit 120 determines (step A13) an estimated invariant entropy using the estimation algorithm (for example the kNN algorithm in this example), as explained below.

In practice, in this example, the estimation algorithm determines, for
the invariant entropy

$$h ( X ) = H ( \frac{X}{m ( X )} )$$

for the ion associated with the first mass spectrum,
the invariant entropy

$$h ( Y ) = H ( \frac{Y}{m ( Y )} )$$

for the ion associated with the second mass spectrum, and
the two-dimensional invariant entropy

$$h ( X , Y ) = H ( \frac{X}{m ( X )} , \frac{Y}{m ( Y )} )$$

as defined in the equation Math. 10 using the equation Math. 3 as defined above to determine each estimated entropy H. The distance formula used in the kNN algorithm is the Euclidean distance defined in the formula Math. 12, with k preferably being equal to 1.

In the step 1041 of determining the mutual information, the processing unit determines (step A2) the conditional information I(X,Y) between the first abundance series and the second abundance series based on the formula Math. 1, now written using the previous calculations using the estimated entropies H:

$$I ( X , Y ) = H ( X ) + H ( Y ) - H ( X , Y ) \qquad [ Math . 20 ]$$

The step 1041 of determining the mutual information is calculated for each pair of series of the series of mass spectra. Thus, for each pair of series of abundance values, the calculated mutual information I corresponds to a correspondence score between the first abundance series and the second abundance series of a given pair of abundance series.

All correspondence scores calculated in the calculation step 1040 (in a step 1042) may thus be represented in the form of a two-dimensional matrix, with for example all first series of abundance values of all pairs along the rows and all second series of abundance values of the pairs along the columns. From this, each “pixel” of the matrix corresponds to a correspondence score calculated based on a given pair of ions, the ions being able to be identified with the row and column of the matrix. These data, illustrated in two dimensions, correspond to the score map (which is a two-dimensional matrix).

FIG. 10 illustrates various mutual information point clouds calculated based on non-invariant estimated entropies H (that is to say based on a first series of abundance values and a second series of abundance values not normalized by their invariance parameter explained above). These curves were plotted with the abundance values (intensity) of an ion (here in particular the ion associated with a first series of abundance values that has an m/z ratio of 1222) on the abscissa and the abundance values of the other ion of the considered pair (here the ion associated with the second series of abundance values that has an m/z ratio of 1712) on the ordinate. In this example, a mixture of proteins comprising ubiquitin, cytochrome C and lysozyme in solution in a mixture of water and methanol at a concentration of 10⁻⁵ mol/1. A region centered on m/z 1760 and with a width of 100 m/z was selected for a tandem mass spectrometry step. The selected ions were then subjected to activation from ultraviolet radiation of 20 eV for 500 ms. Typically, here, the multiplicative constant k was applied to the first series of abundance values and estimated for both series and was calculated with the formula Math. 3 with a given multiplicative constant k, in particular with k equal to 1 for the curve 50, k equal to 5 for the curve 51, and k equal to 10 for the curve 52.

FIG. 11 illustrates various mutual information point clouds calculated based on an invariant estimated entropy H (that is to say based on a first series of abundance values and a second series of abundance values normalized by their invariance parameter as explained above). Typically, the estimated entropy H for both series was calculated with the formula Math. 3 with a given multiplicative constant k, with k equal to 1 for the curve 53, k equal to 5 for the curve 54, and k equal to 10 for the curve 55.

It may be seen that for the curve 50, the curve 51 and the curve 52, the mutual information determined with the various values of the multiplicative constant is different. The multiplicative constant used when calculating the entropy of the first series of abundance values thus affects the calculation of the mutual information. Conversely, for the curve 53, the curve 54 and the curve 55, the mutual information determined with various values of the multiplicative constant is similar. Thus, the multiplicative constant used when calculating the entropy of the first series of abundance values does not affect the calculation of the mutual information.

Consequently, by virtue of the invention, the calculated mutual information is invariant, that is to say it is constant by virtue of the estimated invariant entropy and therefore does not depend on the abundances of the ions in the spectra used. The invariant entropy estimated according to the present disclosure therefore makes it possible to express any estimated entropy value in a single reference frame.

In the method 1000, here in particular in step 1041, the mutual information is calculated for all pairs of series of abundance values. All this mutual information may be concatenated in a score map (step 1042). Thus, in this example, all the mutual information determined in step 1041 makes it possible to obtain the score map.

FIG. 12 illustrates a score map obtained based on a correspondence score based on calculation of the mutual information. The mutual information was calculated based on a series of abundance values obtained on an ionized sample, the series of abundance values comprising values integrated over 10 ranges of mass-to-charge ratio values (that is to say according to the second variant of the determination step). The ionized sample is the same as that of FIG. 10 and FIG. 12, comprising a mixture of proteins comprising ubiquitin, cytochrome C and lysozyme. In this figure, the 10 ranges of m/z ratio values of the ions of the first series of abundance values of the pairs are illustrated in the columns, and the 10 ranges of m/z ratio values of the ions of the second series of abundance values of the pairs are illustrated in the rows. As illustrated in this figure, each range of values is associated with an m/z ratio determined as described above.

It may be seen that the obtained score map is a symmetrical matrix, this having the advantage of carrying out calculations thereafter on only half of the score map. In addition, since fewer pairs of series of abundance values were used, the implementation time of the method 1000 is improved.

A description will now be given of a second embodiment of step 1041. Hereinafter, the calculated mutual information is written directly from the estimated mutual information H by virtue of the equivalence between the entropy h and the entropy H discussed above.

Conditional mutual information.

According to this embodiment, the mutual information used is conditional mutual information that is defined by the following formula:

$$I ( X , Y \vert Z ) = H ( X , Z ) + H ( Y , Z ) - H ( X , Y , Z ) - H ( Z ) \qquad [ Math . 21 ]$$

with X, Y and Z an additional variable, called a conditional variable, and H( ) the estimated entropy.

In practice, the conditional variable Z comprises at least one of the following elements: the total number of ions, known as total ions current (TIC). Typically, the total number of ions is the result of a sum of all ions in a mass spectrum (of the plurality of mass spectra), a series of abundance values of another ion of the mixture, a series of constant abundance values, etc. Hereinafter, TIC is considered. In this case of TIC, each mass spectrum of the plurality of mass spectra has a TIC. All TICs of the plurality of mass spectra form a series of TICs that is used as a partial or conditional variable.

Therefore, based on the series of mass spectra, the processing unit 120 is able to calculate a TIC (the conditional variable) for each mass spectrum of the plurality of mass spectra. This may for example be carried out upstream, for example in the determination step 1020. Thus, based on the plurality of mass spectra, the processing unit 120 obtains a series of conditional variables composed of p conditional variables, with p equal to the total number of mass spectra of the plurality of mass spectra (here p=N).

The conditional mutual information is determined using a method similar to that explained above for the example of the mutual information between two variables.

Thus, in the calculation step 1041, the processing unit uses the kNN algorithm to estimate the entropies H(X, Z), H(Y, Z), H(X, Y, Z) and H(Z) of the equation Math. 21. Similarly, each estimated entropy term is an invariant entropy, as explained above.

In practice, the step of estimating the conditional mutual information comprises steps A1 to A2 as described above, included in the step 1041 of calculating the mutual information.

Thus, for each pair of series of abundance values, an invariant measure is determined for each variable X (corresponding to the first series of abundance values), Y (corresponding to the second series of abundance values), and Z (corresponding to the series of TIC values) in step A11 of the step of estimating entropy H of the calculation step 1041.

In practice, to estimate the entropy H(Z) of the conditional variable, the processing unit 120 calculates, based directly on the series of conditional variables Z, the invariant measure m(Z) associated with this series. To obtain the estimated entropy H(Z) of this series, the processing unit 120 normalizes the series of conditional values by dividing each conditional variable of the series of conditional variables Z by the invariant measure m(z)

$$( calculation of \frac{Z}{m ( Z )} ) .$$

Similarly, the processing unit 120 determines the invariant entropy H(Z) using the formula Math. 3, with L=1 (one neighbor) (step A1). In this same step A1, the estimated entropies H(X, Z), H(Y, Z) and H(X, Y, Z) are determined in this step A1.

In practice, in this example, the estimation algorithm also determines, in this step (in addition to the previous example), the following estimated entropies:

$$H ( X , Z ) = h ( \frac{X}{m ( X )} , \frac{Z}{m ( Z )} ) ;$$

$$H ( Y , Z ) = h ( \frac{Y}{m ( Y )} , \frac{Z}{m ( Z )} ) ; and$$

$$H ( X , Y , Z ) = h ( \frac{X}{m ( X )} , \frac{Y}{m ( Y )} , \frac{Z}{m ( Z )} ) .$$

with X the first series of abundance values and Y the second series of abundance values and Z the series of conditional variables. For this purpose, the processing unit 120 uses the equation Math. 3 as defined above to determine each estimated entropy H. The distance formula used in the kNN algorithm is the Euclidean distance defined in the formula Math. 11.

Thereafter, the processing unit determines the conditional mutual information by applying the formula Math. 20.

A description will now be given of a second embodiment of step 1041.

### Mutual Information Between Three Variables

According to this embodiment, the mutual information is conditional mutual information between three variables, called an information score, and is defined by the following formula:

$$I ( X , Y , Z ) = H ( X ) + H ( Y ) + H ( Z ) - H ( X , Y ) - H ( X , Z ) - H ( Y , Z ) + H ( X , Y , Z ) \qquad [ Math . 22 ]$$

In practice, the conditional variable Z is also a series of abundance values, which may be, like the second example described above, a series of TIC values (makes it possible to overcome variations internal to the system) or a series of abundance values of a third ion (makes it possible to highlight relationships in relation to this third ion) selected from the plurality of mass spectra (similarly to the ion associated with the first and second series of abundance values).

The conditional mutual information between three variables is determined using a method similar to that explained above for the example of the conditional mutual information.

The processing unit thus uses the kNN algorithm to estimate the terms H(X), H(Y), H(Z), H(X, Y), H(X, Z), H(Y, Z) and H(X, Y, Z) of the equation Math. 22. Similarly, each estimated entropy term is an invariant entropy, as explained above.

In practice, the step 1041 of calculating the mutual information between three variables comprises steps A1 to A2 as described above.

The processing unit 120 estimates the invariant entropy of each term H(X), H(Y), H(Z), H(X, Y), H(X, Z), H(Y, Z) and H(X, Y, Z) of the equation Math. 22, in a manner similar to the first and second examples described above.

Thereafter, the processing unit 120 determines the conditional mutual information by applying the formula Math. 22.

As has been explained above, the correspondence score may also be based on a correlation between the first series of abundance values and the second series of abundance values. A description will therefore now be given of a variant of the calculation step 1040 in which the correspondence score is based on a correlation.

### Correlation

According to one variant of the method 1000, the correspondence score may be based on a statistical method. In practice, in this embodiment, the method 1000 is based on a correlation coefficient calculation, but does not involve an entropy calculation.

In this embodiment, the processing unit 120 may calculate the correlation coefficient r_{xy} (in a step 1044 of calculating a correlation coefficient) on each pair of abundance series based on the covariance according to the following formula:

$${Cor}_{xy} = \frac{Cov ( X , Y )}{{s}_{x} {s}_{y}} \qquad [ Math . 23 ]$$

with Cov(X, Y) designating the covariance of the variables X (corresponding for example to the first series of abundance values) and Y (corresponding for example to the second series of abundance values), sₓ corresponding to the standard deviation of the variable X and s_{y} corresponding to the standard deviation of the variable Y. Typically, the standard deviation of the considered variable corresponds to the standard deviation determined based on all abundance values of the considered abundance series.

In practice, according to this embodiment, the processing unit 120 calculates, for each pair of series of abundance values, the covariance between the first series of abundance values and the second series of abundance values according to the random variable covariance formula, defined as follows:

$$Cov ( X , Y ) = E ( XY ) - E ( X ) * E ( Y ) \qquad [ Math . 24 ]$$

with E( ) corresponding to the mathematical expectation of the given variable, here the mathematical expectation of all abundance values of the considered abundance series.

Next, the processing unit 120 determines a standard deviation of the variable X and a standard deviation of the variable Y, the considered standard deviation being defined according to the following formula:

$$s = \sqrt{Var ( X )} = \sqrt{E ( {X}^{2} ) - {( E ( X ) )}^{2}} \qquad [ Math . 25 ]$$

with X the considered variable (here the first series of abundance values or second series of abundance values), E(X) the expectation of the considered random variable and Var(X) the variance of the considered random variable.

Thus, in this embodiment, the processing unit 120 calculates, for each pair of series of abundance values, the covariance as defined in the equation Math. 24 and the standard deviation sₓ associated with the first abundance series and the standard deviation s_{y} associated with the second series of abundance values. It then determines the correlation coefficient Cor_{xy} for each pair of series of abundance values.

Since the calculation step 1040 is carried out iteratively by reiterating the calculation step on each pair of series of abundance values or in parallel on all pairs of abundance series, a multitude of correlations Cor_{xy} are provided at the end of step 1040.

Similarly to the embodiment using a correspondence score based on the calculation of the mutual information, all correlation coefficients calculated on all pairs of series of abundance values are grouped together (step 1042) on a two-dimensional matrix (corresponding to a score map) of a shape similar to that obtained in the context of the mutual information. Thus, compared to FIG. 12, the matrix is made up of correlation coefficients Cor_{xy}. However, the scale of such a score map is different from the example with the mutual information, since the calculated correlation coefficients may be negative or positive (unlike the mutual information, in which the score values are positive).

In addition, although not necessary, it is also possible to determine the correlation coefficients based on series of normalized abundance values. For example, the normalization coefficient may correspond to the invariance parameter of the considered series and calculated in a manner similar to the example of the mutual information.

A description will now be given of a second embodiment of step 1044.

### Partial Correlation

According to another variant of the method 1000, the processing unit 120 may calculate the partial correlation coefficient Cor_{xyz} between two variables X, Y and a third variable Z. This third variable is similar to the variable Z used in the calculation of the mutual information. In other words, the variable Z is a series of TIC values or a series of abundance values of another ion, different from the ion associated with the first and second series of abundance values. It may also be a series made up of constant values or a series of values relating to the intensity of a laser beam, a gas pressure, etc. Using a third variable Z makes it possible to overcome a magnitude affecting the measurements.

In this case, the step of calculating the correlation coefficient 1044 may be implemented as follows.

In practice, the partial correlation coefficient of each pair of series of abundance values is defined according to the following equation:

$${Cor}_{XY \cdot Z} = \frac{{Cor}_{XY} - {Cor}_{XZ} * {Cor}_{YZ}}{\sqrt{1 - {Cor}_{XZ}^{2} * \sqrt{1 - {Cor}_{YZ}^{2}}}} \qquad [ Math . 26 ]$$

with Cor( ) the correlation coefficient between the considered variables.

To this end, the processing unit 120 calculates, for each pair of series of abundance values, the correlation coefficients Cor_{yx}, Cor_{xz} and Cor_{yz} as determined previously using the formula Math. 23 and then applies the formula Math. 26 to determine the partial correlation coefficient between three variables.

The correspondence score obtained by this embodiment is more precise than the correspondence score of the embodiment based on calculating a correlation coefficient between two variables as explained above.

Typically, the numerator in equation 23 is equivalent to standard deviation normalization. Such standard deviation normalization in the correlation calculation has the same effect as invariant measure normalization in the entropy calculation.

FIG. 13 illustrates a score map obtained based on a correspondence score based on a correlation coefficient (here a partial correlation coefficient). The results displayed correspond to the ionized sample comprising melittin and substance P. The correspondence scores were determined based on a series of abundance values obtained on an ionized sample, the series of abundance values comprising non-integrated values (that is to say according to the first variant of the determination step 1020). In this figure, the m/z ratio values of the ions of the first series of abundance values of the pairs are illustrated in the columns (on the abscissa), and the m/z ratio values of the ions of the second series of abundance values of the pairs are illustrated in the rows (on the ordinate).

It may be seen that the score map obtained is a symmetrical matrix. In addition, it may be seen that the more pairs of series of abundance values have been used, the longer the implementation time of the method 1000 may be. The correspondence scores according to this method may be positive or negative.

FIG. 14 illustrates a correspondence score map obtained with series of abundance values filtered by a Kalman filter and illustrated previously (that is to say obtained based on the mixture of melittin and substance P). It may be seen that the score map has a better contrast. Contrast may be evaluated by taking the average of the correspondence scores of all pixels of the correspondence map. In one preferred variant, the contrast may be evaluated by calculating a variance over all correspondence scores (that is to say all pixels) of the score map. In this case, the higher the variance, the greater the contrast.

A description will now be given of a combination of the statistical and probabilistic method for determining the correspondence score calculated in the calculation step 1040.

As has been explained above, the correspondence score may also be based on a correlation between the first series of abundance values and the second series of abundance values and on mutual information between the first series of abundance values and the second series of abundance values.

Combination of the statistical method and of the probabilistic method described above.

In this embodiment, the correspondence score is based on the probabilistic method based on an entropy calculation applied to the first series of abundance values and the second series of abundance values and on the statistical method based on calculating a correlation between the first series of abundance values and the second series of abundance values.

Thus, in practice, the processing unit 120 determines, for each pair of series of abundance values, two preliminary correspondence scores by calculating, for each pair of series of abundance values:
at least one of the items of mutual information (step 1041) described above I(X, Y), I(X, Y|Z), I(X, Y, Z), that is to say by calculating the mutual information defined by one of the following formulas: Math. 20, Math. 21, Math. 22; and
at least one of the correlation scores (step 1044) described above Cor_{xy}, Cor_{xyz}, that is to say by calculating the correlation coefficient defined by one of the following formulas: Math. 23, Math. 26.

Preferably, in this embodiment, the processing unit 120 combines the mutual information between three variables I(X, Y, Z) with the partial correlation coefficient Cor_{xyz}.

In this case, the processing unit 120 may calculate a mixed coefficient Sa(X, Y, Z) (step 1045) over each pair of series of abundance values that is defined according to the following formula:

$$Sa ( X , Y , Z ) = I ( X , Y , Z ) * sign ( {Cor}_{XY \cdot Z} ) \qquad [ Math . 27 ]$$

with sign(Cor_{xyz}) corresponding to the sign of the partial correlation coefficient and I(X, Y, Z) corresponding to the mutual information between three variables.

In one variant of the method 1000, the processing unit 120 may weight at least one of the following terms, namely the mutual information between three variables, the partial correlation coefficient, in order to obtain a more precise correspondence score. In this case, the processing unit 120 calculates a weighted mixed coefficient Sap(X, Y, Z) over each pair of abundance series that may be defined according to the following formula:

$${Sa}_{p} ( X , Y , Z ) = ( alpha * I ( X , Y , Z ) ) * ( beta * {Cor}_{X , Y , Z} ) \qquad [ Math . 28 ]$$

with alpha a first weighting coefficient greater than or equal to 1 and beta a positive second weighting coefficient greater than or equal to 1.

In practice, the first weighting coefficient depends on the correspondence score based on the considered mutual information and the second weighting coefficient depends on the information score based on the considered correlation coefficient.

For example, the correspondence score may be calculated according to the formula Math. 28, in which the conditional mutual information (that is to say the correspondence score based on the conditional mutual information) is multiplied with the partial correlation coefficient and in which the first weighting coefficient is equal to 1 and the second term of the equation Math. 28 is written sign(beta*Cor_{xyz}−0.1), with beta a second correlation coefficient equal to 1. In this example, the value 0.1 is selected, because it makes it possible to reduce a correlation intrinsic to the fragmentation process that the term TIC cannot overcome.

In one variant, the equation Math. 28 may also be written:

$${Sa}_{p} ( X , Y , Z ) = h ( f ( I ( X , Y , Z ) ) , g ( {Cor}_{XYZ} ) )$$

with f( ) and g( ) two functions that apply a transformation to each coefficient (here I(X, Y, Z) and Cor_{xyz}). These functions may be for example a square function, an affine function, a sign function, etc. The function h(a,b) is a function that takes two variables and that applies a transformation, such as an addition or multiplication.

A description will now be given of the other steps of the method 1000 after having obtained one or more correlation maps based on all correspondence scores described above.

In some cases, the one or more correlation maps obtained in step 1042 cannot be used because they have an excessively low contrast. In this case, the method 1000 optionally comprises a step 1050 of selecting the correlation maps according to a contrast of the considered score map.

Such a step makes it possible to eliminate unusable correlation maps so as to limit errors when using the correlation maps in the remainder of the method 1000.

In practice, this selection step 1050 may be calculated directly in the calculation step 1040 after having determined the score map associated with a given correspondence score. In this case, the processing unit 120, after having determined the score map, calculates a contrast of the given score map and then compares this contrast with a given threshold in order to keep or eliminate this correspondence map. For example, the threshold may be a value greater than or equal to 0.30, for example 0.5.

Typically, in one example, the score map resulting from the correspondence score based on two-variable mutual information may have a contrast of less than 0.3. Therefore, following the selection step 1050, this score map may be erased from the memory of the processing unit or the storage module 140.

If only a single type of score map is calculated in the calculation step, a single correspondence map is obtained as a result of step 1040. In this case, if this map has a contrast lower than the threshold, the method may reiterate the calculation step by determining correspondence scores based on another calculation method (that is to say change for example from mutual information between two variables to mutual information between three variables, or change to a score based on a correlation coefficient or use a mixed correlation score, etc.).

The one or more correlation maps that pass the requirement of step 1050 are kept in the memory of the processing unit and/or of the storage module 140. Thus, in the remainder of the method 1000, only the one or more correlation maps kept following the selection step 1050 are used in the remainder of the method 1000. Of course, if the method 1000 does not comprise a selection step 1050 as described above, all correlation maps determined in the calculation step 1040 are used in the method 1000.

In the example illustrated, following the selection step 1050, the method 1000 comprises a step 1060 of determining, based on a mass-to-charge ratio, at least one precursor ion and associated fragment ions. For this purpose, the method 1000 uses a clustering method that is applied to the one or more correlation maps calculated at the end of the calculation step 1040.

Thus, in this step 1060, the processing unit 120 applies, to each score map, a clustering method to determine at least one precursor ion and the fragment ions associated with this precursor ion. This precursor ion is determined according to an m/z ratio.

If multiple precursor ions are determined in this step, each determined precursor ion is associated with its fragment ions.

Optionally, before applying the clustering method to the correlation maps, the method 1000 may comprise a step 1062 of processing the correlation maps. In practice, this processing step 1062 is carried out in the determination step 1060 but before the clustering method is applied.

Typically, the processing step 1062 uses at least one of the following processing operations:
an algorithm for processing the diagonal of the given score map. In this case, the processing unit 120 may assign one and the same score value (for example an integer) to each element present on the diagonal of the score map. For example, all elements on the diagonal may be set to zero, so that these elements do not significantly influence the clustering algorithm. In the case of a score map based on correlation coefficients, the integer may be negative;
an algorithm for standardizing the correlation maps. In this case, the standardization algorithm may be applied to each row of the correlation maps. This standardization algorithm uses an average of a given row and a standard deviation. In practice, the processing unit 120 calculates the average of each row and the standard deviation of each row. Next, for each element of a given row, the processing unit subtracts, from this given element, the average value of the given row, and then divides this value by the standard deviation of the given row. Thus, with this processing operation, each row of the score map has a similar weight in the processed score map;
application of a square function in order to accentuate the deviation between small and large coefficients (correspondence scores) of the given score map.

In this example, the method 1000 then uses a clustering (or classification) method on the processed correlation maps (step 1064).

Typically, the clustering algorithm uses at least one unsupervised learning algorithm that may comprise at least one of the following algorithms:
a hierarchical agglomerative clustering algorithm, for example using a Ward method (as aggregation method) on variance, and/or the complete linkage method,
a k-nearest neighbors algorithm,
a k-means algorithm,
a dimensionality reduction algorithm, also known as a t-distributed stochastic neighbor embedding (t-SNE) algorithm.

In the clustering method, each clustering algorithm takes a score map as input. Thus, if multiple correlation maps are calculated in step 1040 or kept following the selection step, the processing unit 120 will implement multiple clustering algorithms.

The clustering method may also, in the input data, define other elements, comprising at least one of the following parameters: the method used (here for example Ward's method in the case of the unsupervised learning algorithm); the distance used in the (aggregation) method used; etc. These data depend on the type of algorithm used, and are therefore known to those skilled in the art.

A description will now be given, with reference to FIG. 15, FIG. 16, FIG. 17, FIG. 18 and FIG. 19, of one embodiment of the determination step 1060 used in the method 1000.

In the example of the method 1000, the determination step 1060 uses a hierarchical clustering algorithm. In practice, in this example, the algorithm that is used uses Ward's method and takes a Euclidean distance by default. Ward's method is more suitable because it minimizes cluster variance and is recommended for continuous values, unlike the other methods mentioned above, such as the complete linkage method, which takes into account the maximum values and not an overall set of the given score map.

FIG. 15 illustrates a dendrogram obtained by the hierarchical clustering method used and obtained based on the data calculated on the ionized sample from a mixture of melittin and substance P. Here, the dendrogram comprises the various labels corresponding, in this example, to the m/z ratios of the precursor ions and the fragment ions on the abscissa, and a distance between various classes on the ordinate. In this example, each class is characterized by a horizontal line on the dendrogram. Vertical branches/linkages connect the classes so as to illustrate the linkages between the various classes.

As illustrated in FIG. 15, the dendrogram comprises a main class C1 that is divided into two main vertical branches C11, C12, each main vertical branch again being connected to a new class C2, thereby making it possible to obtain a tree structure in which the vertical branches illustrate the linkages/proximities between the various classes connected to these branches.

It may thus be deduced from this dendrogram that the initial mixture comprises two precursor ions (visible by the two linkages of the main branch). Each main branch is connected to a new class (called secondary class) that is connected to secondary linkages, which are themselves connected to a new class. Each branch connecting two classes positioned at two different distances illustrates the distance between these two classes.

The two main branches connected to the main class are thus used to visualize two large clusters/groups of precursor ions, and the secondary branches are used to visualize the fragment ions of this precursor ion. It may be deduced from this that each secondary branch connected to a secondary class corresponds to a fragment of the precursor ion and that the trees (other branches connected to classes positioned at a distance less than that of the given fragment) connected to this secondary class define the chemical compounds of this fragment. Therefore, the final vertical branches (the lowest branches, not connected to any lower class) illustrate the m/z ratios of each chemical compound of the fragment ions of the given precursor ion. Thus, by virtue of this dendrogram, it is possible to directly visualize the m/z ratios of each chemical compound of the fragment ions of the precursor ion of the class.

Thus, after having obtained this dendrogram, the processing unit 120 determines the precursor ions and the fragments associated with each precursor ion by using the various branches and classes of the dendrograms, the distances separating the classes and the m/z ratios given at the distance equal to zero (zero ordinate).

The method 1000 then comprises a step 1070 of reconstructing the individual mass spectrum of each determined precursor ion and of the associated fragments following the determination step 1060. In practice, the processing unit 120 uses the data extracted from the clustering method to reconstruct the mass spectrum of each precursor ion, in particular the m/z ratios grouped together in one and the same class. Thus, for each precursor ion determined in the previous step, the processing unit 120 retrieves each m/z ratio positioned at the minimum distance (equal to zero), and associates an intensity (that is to say an abundance value) with this ratio. This intensity may be calculated based on the series of abundance values corresponding to this ratio, for example by calculating the average abundance value of this series of abundance values, or directly based on the average spectrum by selecting the given m/z ratio on the average spectrum. The processing unit may therefore construct a peak on the mass spectrum of the precursor ion at each determined m/z ratio and assign it a corresponding intensity.

Such a reconstructed mass spectrum corresponds to a tandem mass spectrum of the determined precursor ion. Thus, with the method 1000, it is possible to reconstruct the tandem mass spectrum of each determined precursor ion in the sample that is used by using mass spectra acquired from a single mass spectroscopy device, that is to say without using a tandem mass spectroscopy device.

Optionally in the considered example, the method 1000 comprises verifying the reconstruction 1080, comprising carrying out a comparison between each reconstructed individual mass spectrum and the average mass spectrum obtained based on the plurality of mass spectra (as described above). Such an action makes it possible to verify that the fragments associated with these one or more precursor ions exist, thereby improving the reliability and precision of the reconstruction step 1070.

FIG. 16 and FIG. 17 each illustrate an individual mass spectrum of one of the two precursor ions determined in the previous step.

This FIG. 16 comprises a first mass spectrum 701 of a first determined precursor ion (here the one corresponding to the melittin ion), and FIG. 17 comprises a second mass spectrum 702 of a second determined precursor ion (here the one corresponding to the ion of substance P).

Optionally, these individual mass spectra 701, 702 may be compared with the average mass spectrum illustrated in FIG. 5 in order to verify that the combination of the individual mass spectra 701 and 702 comprises all peaks of the average mass spectrum determined previously. This is the case in this example. This may be carried out following the reconstruction, in the reconstruction step 1070 (step 1071).

As an alternative, the determination step 1060 may use another clustering algorithm (called first clustering algorithm). Similarly to the previous reconstruction step, this other clustering algorithm is applied individually to each correlation map.

In this example, the processing unit 120 uses the t-SNE algorithm as clustering algorithm. Typically, the input data used by this algorithm are similar to those used by the hierarchical clustering algorithm (first clustering algorithm) described above.

FIG. 18 shows a two-dimensional map provided by the t-SNE algorithm. This map comprises a multitude of points depicted on the map. Each point is associated with an m/z ratio.

This algorithm is often used when the ionized sample comprises a number of precursors greater than or equal to 2 and/or when there is a high probability of a fragment ion being common to at least two precursor ions of the ionized mixture. The output data are a list of pairs of coordinates (x,y) for each label (ion). These coordinates make it possible to have a spatial visualization of the various groups highlighted.

The t-SNE algorithm thus makes it possible to obtain a spatial visualization of the precursor ions and fragment ions of the ionized mixture. It is also commonly combined with another clustering algorithm, which in this case takes the map obtained by the t-SNE algorithm as input. In one example, the t-SNE algorithm is combined with a k-means algorithm. FIG. 19 illustrates the use of these two algorithms successively. It is possible to see, on the map obtained by the t-SNR algorithm, two groups G1 and G2 (shown by the dotted lines) each comprising points of the map associated with an m/z ratio. All points contained in the group G1 correspond to the fragment ions of one of the precursor ions of the ionized mixture (here the melittin precursor ion), and all points contained in the group G2 correspond to the fragment ions of another precursor ion of the ionized mixture (here the precursor ion of substance P). These two groups G1 and G2 may also be separated by a straight line D1 determined by the k-means algorithm. It is then possible to associate an abundance value (that is to say intensity) with each point (a given m/z ratio). This abundance value is determined as previously (in the case of the hierarchical clustering algorithm) based on the average mass spectrum or the series of abundance values associated with this m/z ratio.

The method 1000 may also combine multiple clustering methods in order to improve reconstruction precision. By way of example, the method 1000 may use a hierarchical agglomerative clustering algorithm and then a t-SNE algorithm combined with a k-means algorithm. Combining these methods may make it possible to verify and/or complete the one or more reconstructed mass spectra, in particular when multiple precursor ions comprise fragment ions with a similar m/z ratio.

After having reconstructed the individual mass spectrum of each detected precursor ion, the method may optionally comprise a step 1090 of analyzing the individual mass spectrum of the determined precursor ion and the associated fragment ions in order to characterize the chemical composition of the determined precursor ion and the chemical composition of the fragment ions associated with the given precursor ion. Indeed, after the reconstruction step (and after the verification step if present in the method 1000), the chemical composition of the precursor ion and of the various fragments of the precursor ion are unknown (the reconstruction step provides a spectrum with m/z ratios and abundance values associated with each m/z ratio). To this end, the analysis step 1090 makes it possible to recover the chemical composition of the fragments and of the precursor ion of each determined individual mass spectrum. This may typically be carried out using known techniques, using a database comprising (known) reference mass spectra and by comparing each mass spectrum determined by the method 1000 with the reference mass spectra.

1. A method for reconstructing a mass spectrum, said method comprising the following steps:
acquiring (1010) a plurality of mass spectra measured on an ionized sample comprising at least one precursor ion and fragment ions,
determining (1020) a plurality of series of abundance values of the ionized sample based on the plurality of mass spectra, each series of abundance values of the ionized sample being determined based on the plurality of mass spectra, each series of abundance values comprising N abundance values, where N is an integer greater than or equal to two;
arranging (1030) the plurality of series of abundance values into pairs of series of abundance values, each pair of series of abundance values comprising a first series of abundance values and a second series of abundance values,
for each pair of series of abundance values, calculating (1040) a correspondence score between the first series of abundance values and the second series of abundance values, so as to obtain correspondence scores for all pairs of series of abundance values, the correspondence scores providing a correspondence score map between all pairs of series of abundance values,
determining (1060), based on a mass-to-charge ratio, at least one precursor ion and fragment ions associated with each determined precursor ion, by applying a clustering method to the calculated correspondence score map,
reconstructing (1070) an individual mass spectrum of each determined precursor ion and of each of the associated fragment ions based on the correspondence score map.

2. The method as claimed in claim 1, wherein the step of determining a series of abundance values comprises determining a series of ranges of mass-to-charge ratio values for the plurality of measured mass spectra of size N×M, with M an integer greater than 1, and for each mass spectrum of the plurality of mass spectra, a step of integrating abundance values belonging to one and the same range of mass-to-charge ratio values of the considered mass spectrum, in order to provide, for each range of mass-to-charge ratio values of the considered spectrum, an integrated abundance value associated with a mass-to-charge ratio, the abundance values integrated over the series of ranges of mass-to-charge ratio values forming a series of abundance values of the ionized sample.

3. The method as claimed in claim 1, wherein the correspondence score is based on at least one of the following elements:
mutual information between the first series of abundance values and the second series of abundance values, said mutual information being based on an entropy of the first series of abundance values and on an entropy of the second series of abundance values; and/or
a correlation between the first series of abundance values and the second series of abundance values.

4. The method as claimed in claim 3, wherein, for the mutual information, the entropy of the first series of abundance values is an entropy normalized by a first invariance parameter dependent on a first median value determined over this first series of abundance values, and the entropy of the second series of abundance values is an entropy normalized by a second invariance parameter dependent on a second median value determined over this second series of abundance values.

5. The method as claimed in claim 3, wherein, with the correspondence score being based on mutual information, the method comprises a step of estimating the entropy of the first series of abundance values and a step of estimating the entropy of the second series of abundance values using a k-nearest neighbors algorithm.

6. The method as claimed in claim 5, wherein the k-nearest neighbors algorithm is applied to a single neighbor.

7. The method as claimed in claim 3, wherein, when at least two correspondence scores based on two different elements are calculated in the calculation step, multiple score maps are provided following the calculation step, said method further comprising, for each score map, a step (1050) of filtering said score map based on a contrast of the considered score map.

8. The method as claimed in claim 1, further comprising a step (1062) of processing the score map before applying the clustering method, said processing step using at least one of the following algorithms:
a standardization algorithm,
an algorithm for processing diagonal elements of the score map,
application of a square function.

9. The method as claimed in claim 1, wherein the score map is a two-dimensional matrix, the clustering method determining the at least one precursor ion and its associated fragment ions based on correspondence scores located outside a diagonal of the score map.

10. The method as claimed in claim 1, wherein the clustering method uses at least one unsupervised learning algorithm.

11. The method as claimed in claim 1, wherein the clustering method is based on at least one of the following algorithms:
a hierarchical agglomerative clustering algorithm,
a k-nearest neighbors algorithm,
a k-means algorithm,
a distributed stochastic neighbor embedding algorithm.

12. The method as claimed in claim 1, further comprising, after the reconstruction step (1070), a step (1090) of analyzing the individual mass spectrum of the determined precursor ion and the associated fragment ions in order to characterize the chemical composition of the determined precursor ion and the chemical composition of the fragment ions associated with the considered precursor ion in question.

13. The method as claimed in claim 1, wherein the method comprises a step (1015) of processing the acquired mass spectra, comprising at least one of the following calculations:
filtering the given mass spectrum by way of a Gaussian or normal kernel,
normalizing the given mass spectrum,
smoothing the given mass spectrum,
baseline correction.

14. The method as claimed in claim 1, wherein the method comprises a step (1025) of processing the series of abundance values, comprising at least one of the following calculations:
filtering the given series of abundance values by way of a Kalman filter;
filtering the given series of abundance values by way of a Fourier filter;
filtering the given series of abundance values by way of a moving average.

15. The method as claimed in claim 1, wherein an external variation based on chromatographic separation, ion mobility separation and/or discriminant transmission of ion optics is applied during the acquisition step so as to modify the abundance of ions, and wherein the number of mass spectra of the plurality of mass spectra is less than or equal to 10.
